(19) United States
(12) Patent Application Publication
(10) Pub. No.: US 2026/0146138 A1
(43) Pub. Date: May 28, 2026

(54) METHODS OF RECYCLING POLYVINYL BUTYRAL

(71) Applicant: SOLUTIA INC., ST. LOUIS, MO (US)

(72) Inventors: YINONG MA, LONGMEADOW, MA (US); ROBERT LIN, KINGSPORT, TN (US); ZHUFANG LIU, KINGSPORT, TN (US); PINGUAN ZHENG, JOHNSON CITY, TN (US)

(73) Assignee: SOLUTIA INC., ST. LOUIS, MO (US)

(21) Appl. No.: 19/103,047

(22) PCT Filed: Oct. 3, 2023
(86) PCT No.: PCT/US2023/075769

§ 371 Date: Feb. 11, 2025

Related U.S. Application Data
(60) Provisional application No. 63/412,922, filed on Oct. 4, 2022.
(60) Provisional application No. 63/412,925, filed on Oct. 4, 2022.
(60) Provisional application No. 63/412,930, filed on Oct. 4, 2022.
(60) Provisional application No. 63/412,931, filed on Oct. 4, 2022.
(60) Provisional application No. 63/412,934, filed on Oct. 4, 2022.

(51) Int. Cl. C08J 11/16; C08F 8/12; C08J 11/14

(52) U.S. Cl. CPC C08J 11/16; C08F 8/12; C08J 11/14; C08J 2329/14

(57) ABSTRACT

Methods of converting polyvinyl butyral (PVB) to its raw constituents (e.g., polyvinyl alcohol (PVOH) and butyraldehyde) via hydrolysis. The methods facilitate hydrolyzing a PVB feed composition, which may be derived from recycle content material, into its raw constituents. The regenerated PVOH, PVB with a higher residual PVOH content, and/or butyraldehyde recovered from this process may then be used to produce purified and/or regenerated PVB.

### BACKGROUND

Waste materials, especially non-biodegradable waste materials, can negatively impact the environment when disposed of in landfills after a single use. Thus, from an environmental standpoint, it is desirable to recycle as much waste material as possible. However, recycling waste materials can be challenging from an economic standpoint. To maximize recycling efficiency, it is desirable for large-scale production facilities to process feedstocks having recycle content originating from a variety of waste materials. Commercial facilities involved in the production of non-biodegradable products or products that find their ultimate destination in a landfill could benefit greatly from using recycle content feedstocks.

Polyvinyl butyral (PVB) is often used in the manufacture of polymer sheets that can be used as interlayers in multiple layer panels, including, for example, light-transmitting laminates such as safety glass or polymeric laminates. PVB is also used in photovoltaic solar panels to encapsulate the panels which are used to generate and supply electricity for commercial and residential applications. PVB waste derived from the production and/or disposal of such PVB products is generally unsuitable to be recycled into other products without intervening processing. For example, one or more of additives, adhesives, plasticizers, and the like, may be present in the PVB waste. Such additives generally must be removed from PVB waste for the PVB to be recycled.

Thus, it is desirable to develop processes for efficiently recycling low quality PVB or PVB waste to produce recycle content polymeric materials.

### SUMMARY

Provided herein is a method of recycling polyvinyl butyral (PVB). The method comprises hydrolyzing or partially hydrolyzing a PVB feedstock to produce a solution comprising regenerated polyvinyl alcohol (r-PVOH) derived from the PVB feedstock.

Also provided herein is a method of recycling polyvinyl butyral (PVB). The method comprises producing a plurality of PVB particles from fresh polyvinyl alcohol and fresh butyraldehyde in the presence of water, hydrolyzing a quantity of the PVB particles to produce a solution comprising regenerated PVOH (r-PVOH), and producing, in the presence of water, additional PVB particles from the r-PVOH.

### BRIEF DESCRIPTION OF THE FIGURES

FIG. 1 is a schematic diagram of an example process for recycling polyvinyl butyral.

FIG. 2 is a schematic diagram of an alternative process for recycling polyvinyl butyral.

FIG. 3 is a schematic diagram of an example process for producing and recycling polyvinyl butyral.

FIG. 4 is a schematic diagram of an alternative process for producing and recycling polyvinyl butyral.

FIG. 5 is a schematic diagram of an example process for recycling polyvinyl butyral by partial hydrolysis.

FIG. 6 is a schematic diagram of an alternative process for recycling polyvinyl butyral by partial hydrolysis.

FIG. 7 is a schematic diagram of an alternative process for recycling polyvinyl butyral by partial hydrolysis.

FIG. 8 is a schematic diagram of an example process for producing and recycling polyvinyl butyral by partial hydrolysis.

FIG. 9 is a schematic diagram of an example process for producing and recycling polyvinyl butyral by partial hydrolysis.

FIG. 10 is a schematic diagram of an example process for producing and recycling polyvinyl butyral by partial hydrolysis.

FIG. 11 is a schematic diagram of an example process for recycling polyvinyl butyral with alcohol-based aldehyde scavenging.

FIG. 12 is a schematic diagram of an alternative process for recycling polyvinyl butyral with alcohol-based aldehyde scavenging.

FIG. 13 is a schematic diagram of an example process for recycling polyvinyl butyral with amine-based aldehyde scavenging.

FIG. 14 is a schematic diagram of an alternative process for recycling polyvinyl butyral with amine-based aldehyde scavenging.

FIG. 15 is a schematic diagram of an example process for recycling polyvinyl butyral via hydrogenation.

### DETAILED DESCRIPTION

Further provided herein is a method of recycling polyvinyl butyral (PVB). The method comprises partially hydrolyzing a PVB feedstock to produce a reaction product comprising unreacted PVB and butyraldehyde, wherein the unreacted PVB comprises residual polyvinyl alcohol (PVOH). The method also comprises reacting the residual PVOH with additional butyraldehyde to produce regenerated PVB.

Also provided herein is a method of recycling polyvinyl butyral (PVB). The method comprises producing a plurality of PVB particles from fresh polyvinyl alcohol (PVOH) and fresh butyraldehyde in the presence of water, partially hydrolyzing a quantity of the PVB particles to produce a reaction product comprising unreacted PVB and butyraldehyde, wherein the unreacted PVB comprises residual PVOH, and reacting the residual PVOH with additional butyraldehyde to produce regenerated PVB.

Provided herein is a method of recycling polyvinyl butyral (PVB). The method comprises hydrolyzing, in the presence of hydrogen and a hydrogenation catalyst, a PVB feedstock to produce a solution comprising regenerated polyvinyl alcohol (PVOH) and regenerated butanol.

Also provided herein is a method of recycling polyvinyl butyral (PVB). The method comprises producing a plurality of PVB particles from fresh polyvinyl alcohol (PVOH) and fresh butyraldehyde in the presence of water; hydrolyzing, in the presence of at least one aminofunctional compound, a quantity of the PVB particles to produce a solution comprising regenerated PVOH and regenerated butanol; and producing, in the presence of water, additional PVB particles from the regenerated PVOH.

Provided herein is a method of recycling polyvinyl butyral (PVB). The method hydrolyzing, in the presence of an aldehyde scavenger, a PVB feedstock to produce a solution comprising regenerated polyvinyl alcohol (PVOH) and regenerated acetal.

Also provided herein is a method of recycling polyvinyl butyral (PVB). The method comprises producing a plurality of PVB particles from fresh polyvinyl alcohol and fresh butyraldehyde in the presence of water, hydrolyzing, in the presence of an aldehyde scavenger, a quantity of the PVB particles to produce a solution comprising regenerated PVOH, and producing, in the presence of water, additional PVB particles from the regenerated PVOH.

Provided herein is a method of recycling polyvinyl butyral (PVB). The method comprises hydrolyzing, in the presence of at least one aminofunctional compound, a PVB feedstock to produce a solution comprising regenerated polyvinyl alcohol (PVOH) and one or more butyl imine derivatives.

Also provided herein is a method of recycling polyvinyl butyral (PVB). The method comprises producing a plurality of PVB particles from fresh polyvinyl alcohol and fresh butyraldehyde in the presence of water, hydrolyzing, in the presence of at least one aminofunctional compound, a quantity of the PVB particles to produce a solution comprising regenerated PVOH and one or more butyl imine derivatives, and producing, in the presence of water, additional PVB particles from the regenerated PVOH.

What is embodied is:
E1. A method of recycling polyvinyl butyral (PVB), the method comprising: hydrolyzing or partially hydrolyzing a PVB feedstock to produce a solution comprising regenerated polyvinyl alcohol (PVOH) derived from the PVB feedstock.
E2. The method in accordance with Embodiment E1, wherein the hydrolyzing or partial hydrolyzing does not occur in the presence of a catalyst.
E3. The method in accordance with Embodiment E2, wherein the hydrolyzing or partial hydrolyzing does not occur in the presence of a catalyst and is carried out at a temperature within a range between about 150° C. and about 250° C.
E4. The method in accordance with Embodiments E1, wherein the hydrolyzing or partial hydrolyzing occurs in the presence of an acid catalyst.
E5. The method in accordance with Embodiment E4, wherein the acid catalyst comprises at least one of organic sulfonic acid, nitric acid, sulfuric acid, or hydrochloric acid.
E6. The method in accordance with Embodiment E4, wherein the hydrolyzing or partial hydrolyzing is carried out in the presence of an acid catalyst and a co-catalyst that forms a labile hydrolyzable molecule, for example an amine, an alcohol, or an amino-alcohol, as described elsewhere herein.
E7. The method in accordance with any of Embodiments E5 or E6, wherein the hydrolyzing or partial hydrolyzing is carried out in the presence of the acid catalyst and at a temperature within a range between about 70° C. and about 150° C.
E8. The method in accordance with any of any of Embodiments E1-E7 where the PVB feedstock is hydrolyzed to PVOH with a conversion of at least 90 percent.
E9. The method in accordance with any of Embodiments E1-E7, wherein the PVB feedstock is partially hydrolyzed to a conversion of less than 90 percent, less than 80 percent, less than 70 percent, less than 60 percent, less than 50 percent, less than 40 percent, less than 30 percent, between 20 percent and 90 percent, between 30 percent and 90 percent, between 40 percent and 90 percent, between 50 percent and 90 percent, between 50percent and 80 percent, or between 50 percent and 70 percent.
E10. The method in accordance with any of Embodiments E1-E7 and 9, wherein the partially hydrolyzing of the PVB feedstock produces a slurry that comprises between 25 percent and 75 percent, between 30 percent and 70 percent, between 35 percent and 65 percent, or between 40 percent and 60 percent water-insoluble PVB by weight.
E11. The method in accordance with any of Embodiments E1-E7 and 9, wherein the partially hydrolyzing of the PVB feedstock produces a slurry that comprises greater than 25 percent, greater than 50 percent, greater than 75 percent, between 25 percent and 75 percent, between 30 percent and 70 percent, between 35 percent and 65 percent, or between 40 percent and 60 percent water by weight.
E12. The method in accordance with any of Embodiments E1-E11 further comprising cooling the regenerated PVOH prior to the reacting step.
E13. The method in accordance with any of Embodiments E1-E12 further comprising centrifuging the solution to remove one or more non-soluble components from the solution prior to a filtration step.
E14. The method in accordance with Embodiments E1-E13 where the PVB feedstock is derived from at least one of post-industrial recycle or post-consumer recycle material.
E15. The method in accordance with any of Embodiments E1-E14, wherein the PVB feedstock has a residual PVOH content of at least 8, at least 9, at least 9.5, at least 10, at least 10.5, at least 11, at least 11.5, at least 12, at least 12.5, at least 13, at least 13.5, at least 14, at least 14.5, at least 15, at least 15.5, at least 16, at least 16.5, at least 17, at least 17.5, at least 18, at least 18.5, at least 19, at least 19.5, at least 20, at least 25, at least 26, at least 30, at least 32, at least 35, at least 40, at least 50, at least 60, at least 70, at least 80, or at least 90 percent, and/or not more than 100, not more than 90, not more than 80, not more than 70, not more than 60, not more than 50, not more than 40, not more than 35, not more than 32, not more than 30, not more than 25, not more than 22, not more than 20, not more than 19, not more than 18, not more than 17, not more than 16, not more than 15, not more than 14, not more than 13, not more than 12, not more than 11, not more than 10, not more than 9, or not more than 8 percent.
E16. The method in accordance with any of Embodiments E1-E15, wherein the PVB feedstock comprises two or more PVB resins having different compositions from one another.
E17. The method in accordance with any of Embodiments E1-E16, wherein the PVB feedstock comprises two or more PVB resins having different residual PVOH contents from one another.
E18. The method in accordance with any of Embodiments E1-E17, wherein the PVB feedstock comprises at least 1, at least 5, at least 10, at least 15, at least 20, at least 25, at least 30, at least 35, at least 40, at least 45, at least 50, at least 55, at least 60, at least 65, at least 70, at least 75, at least 80, at least 85, or at least 90 phr, and/or not more than 100, not more than 90, not more than 85, not more than 80, not more than 75, not more than 70, not more than 65, not more than 60, not more than 55, not more than 50, not more than 45, not more than 40, not more than 35, not more than 30, not more than 25, not more than 20, not more than 15, or not more than 10 phr of plasticizer, based on the total weight of the PVB feedstock.
E19. The method in accordance with Embodiments E1-E18 further comprising extracting plasticizer from the PVB feedstock.
E20. The method in accordance with any of Embodiments E1-E19 further comprising size-reducing the PVB feedstock prior to the hydrolyzing step to an average particle size of less than about 400 microns, 350 microns, 300 microns, or 250 microns, or between about 200 and about 400 microns, between about 225 microns and about 375 microns, or between about 250 microns and about 350 microns.
E21. The method in accordance with any of Embodiments E1-E20 further comprising reacting the residual PVOH with butyraldehyde to produce the regenerated PVB having a residual PVOH content of between 1 percent and 90 percent, between 5 percent and 30 percent, between 7 percent and 30 percent, or between 16 percent and 20 percent.
E22. The method in accordance with any of Embodiments E1-E21 further comprising reacting the residual PVOH with butyraldehyde to produce regenerated PVB having a target residual PVOH content, wherein the PVB feedstock has a residual PVOH content that is greater than 1 percent, greater than 2 percent, greater than 3 percent, greater than 4 percent, greater than 5 percent, or greater than 10 percent from the target residual PVOH content.
E23. The method in accordance with any of Embodiments E1-E22 further comprising recovering butyraldehyde produced in the hydrolyzing step.
E24. The method in accordance with any of Embodiments E1-E23 further comprising reacting the residual PVOH with butyraldehyde recovered from the hydrolyzing step to produce regenerated PVB.

The present application generally relates to methods of converting polyvinyl butyral (PVB) to its raw constituents (e.g., polyvinyl alcohol (PVOH) and butyraldehyde) via hydrolysis, and to producing purified PVB from the recovered PVOH and/or butyraldehyde. In general, PVOH and butyraldehyde are the starting materials in a PVB polymerization reaction. The methods described herein facilitate reversing the polymerization reaction by hydrolyzing, or “de-acetalizing,” a PVB feed composition into its raw constituents. The regenerated PVOH and/or butyraldehyde recovered from this process may then be used to produce purified and/or regenerated PVB. When the PVB being converted via hydrolysis is a waste PVB (e.g., off-spec PVB, scrap PVB, and/or post-consumer PVB), the regenerated materials (e.g., r-PVOH, r-butyraldehyde, and r-PVB) produced from the waste PVB can have recycled content from the waste PVB.

The PVB feed composition may be derived from post-consumer recycled PVB, from industrial off-spec PVB, and/or from industrial scrap PVB, where the industrial off-spec PVB may be produced in the normal course of PVB resin production and the industrial scrap PVB may be produced in the normal course of PVB interlayer production. For example, some PVB produced from the polymerization of PVOH and butyraldehyde may be unusable (i.e., off-spec) even when the polymerization is performed at, or near, optimum conditions. In addition, during the extrusion of PVB-containing interlayers, scrap PVB can be produced by, for example, trimming the edges of the PVB sheet.

Thus, the methods described herein facilitate the reduction of non-biodegradable waste, such as waste PVB, and the production of purified PVB from such waste and/or from unusable PVB. That is, the methods described herein provide for the regeneration of polymer products, similar to the products of PVB polymerization from fresh raw constituents, with minimal impact in comparable product quality and environmental impact.

For example, the methods described herein may include the steps of (a) size-reducing a PVB feed composition, (b) optionally dissolving the size-reduced PVB in a solvent, (c) hydrolyzing the PVB to produce a PVOH solution, (d) recovering regenerated PVOH from the solution, (e) producing regenerated PVB from the regenerated PVOH, (f) inspecting the regenerated PVB for defects, (g) hydrolyzing off-spec PVB to produce additional PVOH, and (h) producing additional regenerated PVB from the additional PVOH.

The methods described herein may also include the steps of (a) producing PVB from fresh PVOH and butyraldehyde, (b) inspecting the produced PVB for defects, (c) optionally size-reducing off-spec PVB, (d) hydrolyzing the off-spec PVB to produce regenerated PVOH, and (e) producing additional PVB from the regenerated PVOH.

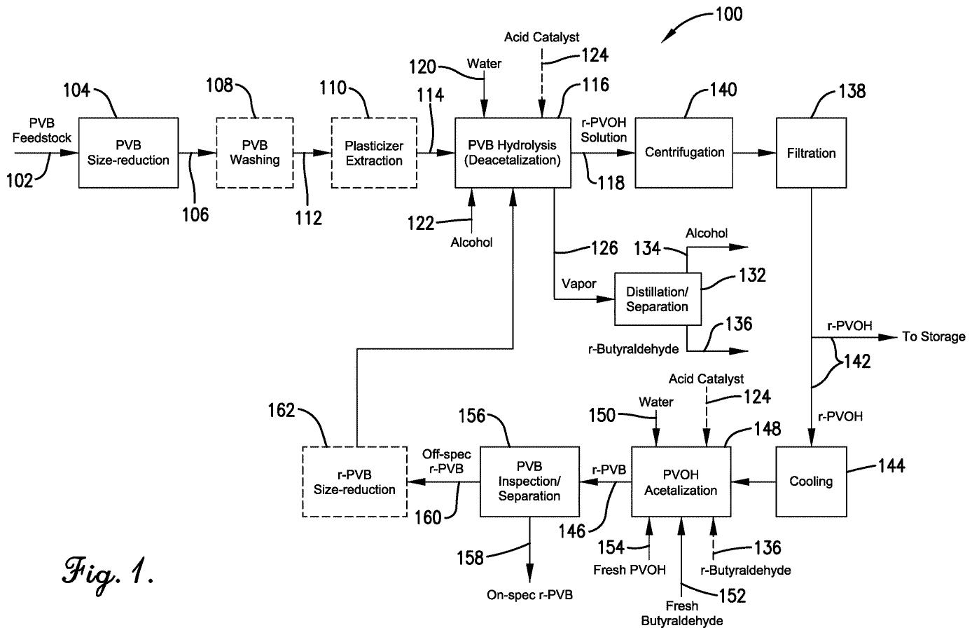

Systems and equipment for practicing these methods, as well as the details and features thereof, may vary. Non-limiting examples of the systems, equipment, and/or steps for use in performing the embodiments of the present disclosure are illustrated in FIGS. 1-4.

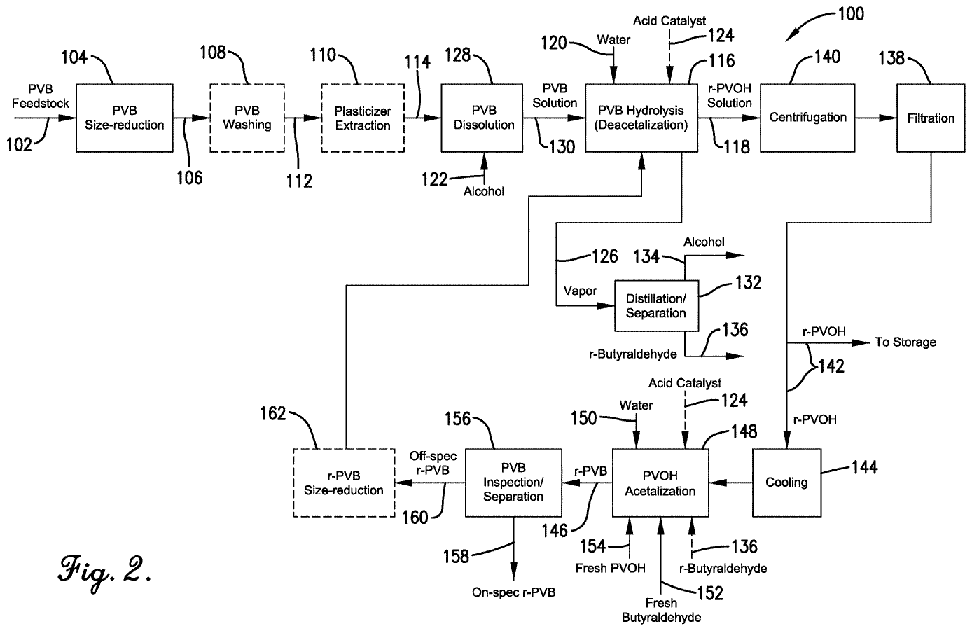

Referring now to FIGS. 1 and 2, a chemical recycling facility 100 is designed to process a PVB feedstock 102 to produce purified and/or regenerated PVB, as described above. In some embodiments, PVB feedstock 102 is derived from a chemical recycling feedstock comprising one or more PVB feed compositions from a feedstock source material. As used herein, the term “PVB feed composition” refers to used, scrap, and/or discarded PVB feed compositions, such as waste PVB typically sent to a landfill.

PVB feedstock 102 may include unprocessed or partially processed PVB feed compositions. As used herein, the term “unprocessed PVB feed composition” refers to PVB feed compositions that have not been subjected to any automated or mechanized sorting, washing, or comminuting. Partially processed PVB feed compositions may originate from, for example, reclaimers. In one embodiment or in combination with any embodiment mentioned herein, PVB feedstock 102 may comprise a post-industrial recycle PVB feed composition and/or a post-consumer recycle PVB feed composition.

In one embodiment or in combination with any embodiment mentioned herein, all or a portion of PVB feedstock 102 can originate from a reclaimer facility that recovers glass from discarded and scrap glass laminates containing PVB interlayers.

As used herein, the term “chemical recycling feedstock” refers to the total feedstock fed into chemical recycling facility 100 and encompasses all feedstock streams that are introduced therein.

Chemical recycling facility 100 may include a feed system for introducing the chemical recycling feedstock comprising PVB feedstock 102, such as a solid PVB resin, into the facility. The feed system can be any conventional feed system for handling a solid particulate feed, such as a screw feeder or a belt conveyance system.

In one embodiment or in combination with any embodiment mentioned herein, the chemical recycling feedstock may comprise at least 25, at least 50, at least 60, at least 65, at least 70, at least 75, at least 80, at least 85, at least 90, at least 95, or at least 99 weight percent of at least 1, 2, 3, 4, 5, or 6 PVB feed compositions, based on the total weight of the stream. Additionally, or in the alternative, the chemical recycling feedstock may comprise less than 99, less than 95, less than 90, less than 85, less than 80, less than 75, or less than 70 weight percent of at least 1, 2, 3, 4, 5, or 6 PVB feed compositions, based on the total weight of the stream.

In one embodiment or in combination with any embodiment mentioned herein, the chemical recycling feedstock fed into the chemical recycling facility consists essentially of or consists of at least 1, 2, 3, 4, 5, or 6 PVB feed compositions.

In one embodiment or in combination with any embodiment mentioned herein, the chemical recycling feedstock fed into the chemical recycling facility consists essentially of or consists of a single PVB feed composition.

In one embodiment or in combination with any embodiment mentioned herein, the chemical recycling feedstock comprises less than 10, less than 5, less than 2, less than 1, less than 0.5, or less than 0.1 weight percent of halogenated plastics, such as polyvinyl chloride, based on the total weight of the stream.

In one embodiment or in combination with any embodiment mentioned herein, the chemical recycling feedstock comprises less than 10, less than 5, less than 2, less than 1, less than 0.5, or less than 0.1 weight percent of a polyolefin (e.g., polypropylene and/or polyethylene) and/or a polyester (e.g., polyethylene terephthalate), based on the total weight of the stream.

In one embodiment or in combination with any of the mentioned embodiments, the chemical recycling feedstock comprises not more than 20, not more than 15, not more than 12, not more than 10, not more than 8, not more than 6, not more than 5, not more than 4, not more than 3, not more than 2, or not more than 1 weight percent of biowaste materials, based on the total weight of the stream. As used herein, the term “biowaste” refers to material derived from living organisms. Exemplary biowaste materials include, but are not limited to, cotton, wood, saw dust, food scraps, animals and animal parts, plants and plant parts, and manure.

In one embodiment or in combination with any embodiment mentioned herein, PVB feedstock 102 may comprise one or more thermoplastic polymers in addition to the PVB or instead of the PVB. Examples of suitable thermoplastic polymers can include, but are not limited to, poly(vinyl acetal) resins, polyurethanes (PU), poly(ethylene-co-vinylacetate) (EVA), polyvinyl chlorides (PVC), poly(vinylchloride-co-methacrylate), polyethylenes, polyolefins, ethylene acrylate ester copolymers, poly(ethylene-co-butyl acrylate), silicone elastomers, epoxy resins, acid copolymers (e.g., ethylene/carboxylic acid copolymers and ionomers thereof), or combinations thereof.

When the PVB feed compositions described herein include PVB resins, the PVB resins can be formed according to any suitable method. PVB resins can be formed by acetalization of polyvinyl alcohol with one or more aldehydes, optionally in the presence of an acid catalyst. The resulting resin can then be separated, stabilized, and dried according to known methods such as, for example, those described in U.S. Pat. Nos. 2,282,057 and 2,282,026, as well as Wade, B. 2016, Vinyl Acetal Polymers, Encyclopedia of Polymer Science and Technology. 1-22 (online, copyright 2016 John Wiley & Sons, Inc.), the disclosures of which are incorporated herein by reference in their entireties. The resulting PVB resins may have a total percent acetalization of at least 50, at least 60, at least 70, at least 75, at least 80, at least 85 weight percent, or at least 90 weight percent as measured according to ASTM D-1396, unless otherwise noted. The total amount of aldehyde residues in the PVB resin can be collectively referred to as the acetal component, with the balance of the PVB resin being residual vinyl alcohol (hydroxyl) and residual acetate groups, which will be discussed in further detail below.

In one embodiment or in combination with any embodiment mentioned herein, the PVB resin in PVB feedstock 102 can be a poly(vinyl n-butyral) resin that mainly comprises residues of butanal, and may, for example, include not more than 50, not more than 40, not more than 30, not more than 20, not more than 10, not more than 5, or not more than about 2 weight percent of residues of an aldehyde other than butanal, based on the total weight of all aldehyde residues of the resin.

In one embodiment or in combination with any embodiment mentioned herein, the molecular weight of the PVB resins in PVB feedstock 102 can be at least 50,000, at least 70,000, or at least 100,000 Daltons and/or not more than 800,000, not more than 550,000, not more than 500,000, not more than 450,000, not more than 425,000 Daltons, or not more than 300,000 Daltons, as measured by size exclusion chromatography using low angle laser light scattering (SEC/LALLS) method of Cotts and Ouano. As used herein, the term “molecular weight” refers to weight average molecular weight (Mw). The molecular weight of the PVB resin can be in the range of from about 50,000 to about 600,000, about 70,000 to about 450,000, or about 100,000 to about 425,000 Daltons.

In one embodiment or in combination with any embodiment mentioned herein, PVB feedstock 102 may comprise at least 1, at least 5, at least 10, at least 25, at least 50, at least 60, at least 70, at least 80, at least 85, at least 90, at least 95, or at least 98 weight percent of a PVB resin, based on the total weight of the PVB feed composition.

In one embodiment or in combination with any embodiment mentioned herein, the chemical recycling feedstock may comprise at least two different PVB feed compositions including at least a first PVB feed composition and a second PVB feed composition, with the first PVB feed composition having a different PVB content relative to the second PVB feed composition. For example, the difference between the PVB content of the first PVB feed composition and the second PVB feed composition may be at least 2, at least 5, at least 10, at least 12, at least 15, at least 20, or at least 30 weight percent. As used herein, the term “weight percent different” or “the difference . . . is at least . . . weight percent” refers to a difference between two given weight percentages, calculated by subtracting the one number from the other.

In one embodiment or in combination with any embodiment mentioned herein, the PVB feed composition may comprise two or more PVB resins having different compositions. For example, in some embodiments, one or both of the outer skin layers of an interlayer forming the PVB feed composition may be formed from a first PVB resin, while the core or inner layer can be formed from a second PVB resin. In such embodiments, the first PVB resin used to form the outer layers can have a residual polyvinyl alcohol content and/or residual acetate content that is at least 2, at least 3, at least 4, at least 5, at least 6, or at least 8 weight percent higher or lower than the residual polyvinyl alcohol content and/or residual acetate content of the second PVB resin used to form the inner layer.

As used herein, the terms “residual polyvinyl alcohol content” and “residual acetate content” refer to the amount of hydroxyl and acetate groups, respectively, that remain on a resin after processing is complete. For example, polyvinyl n-butyral can be produced by hydrolyzing polyvinyl acetate to polyvinyl alcohol, and then acetalizing the polyvinyl alcohol (“PVOH”) with butanal to form polyvinyl n-butyral. In the process of hydrolyzing the polyvinyl acetate, not all of the acetate groups are converted to hydroxyl groups, and residual acetate groups remain on the resin. Similarly, in the process of acetalizing the polyvinyl alcohol, not all of the hydroxyl groups are converted to acetal groups, which also leaves residual hydroxyl groups on the resin. As a result, most poly(vinyl acetal) resins include both residual PVOH groups (as vinyl hydroxyl groups) and residual acetate groups (as vinyl acetate groups) as part of the polymer chain. The residual PVOH content and residual acetate content are expressed in weight percent, based on the weight of the polymer resin, and are measured according to ASTM D-1396, unless otherwise noted.

In one embodiment or in combination with any embodiment mentioned herein, the PVB feed composition may comprise a percent residual polyvinyl alcohol (PVOH) content of at least 8, at least 9, at least 9.5, at least 10, at least 10.5, at least 11, at least 11.5, at least 12, at least 12.5, at least 13, at least 13.5, at least 14, at least 14.5, at least 15, at least 15.5, at least 16, at least 16.5, at least 17, at least 17.5, at least 18, at least 18.5, at least 19, at least 19.5, at least 20, at least 25, at least 26, at least 30, at least 32, at least 35, at least 40, at least 50, at least 60, at least 70, at least 80, or at least 90 percent and/or not more than 100, not more than 90, not more than 80, not more than 70, not more than 60, not more than 50, not more than 40, not more than 35, not more than 32, not more than 30, not more than 25, not more than 22, not more than 20, not more than 19, not more than 18, not more than 17, not more than 16, not more than 15, not more than 14, not more than 13, not more than 12, not more than 11, not more than 10, not more than 9, or not more than 8 percent. For example, the PVB feed composition may comprise a percent residual polyvinyl alcohol (PVOH) content in the range of from about 14 to about 45, about 16 to about 30, about 18 to about 25, about 18.5 to about 20, or about 19.5 to about 21 weight percent.

In one embodiment or in combination with any embodiment mentioned herein, the chemical recycling feedstock may comprise at least two different PVB feed compositions including at least a first PVB feed composition and a second PVB feed composition, with the first PVB feed composition having a different residual PVOH content relative to the second PVB feed composition. For example, the difference between the residual PVOH content of the first PVB feed composition and the second PVB feed composition may be at least 2, at least 5, at least 10, at least 12, at least 15, at least 20, or at least 30 weight percent.

In one embodiment or in combination with any embodiment mentioned herein, the PVB feed composition may comprise a residual acetate content of at least 5, at least 8, at least 10, at least 12, at least 14, at least 16, at least 18, at least 20, or at least 30 weight percent and/or less than 90, less than 80, less than 70, or less than 60 weight percent.

In one embodiment or in combination with any embodiment mentioned herein, the chemical recycling feedstock may comprise at least two different PVB feed compositions including at least a first PVB feed composition and a second PVB feed composition, with the first PVB feed composition having a different residual acetate content relative to the second PVB feed composition. For example, the difference between the residual acetate content of the first PVB feed composition and the second PVB feed composition may be at least 2, at least 5, at least 10, at least 12, at least 15, at least 20, or at least 30 weight percent and/or not more than 15, not more than 13, not more than 11, not more than 9, not more than 8, not more than 6, not more than 5, not more than 4, not more than 3, not more than 2, not more than 1, or not more than 0.5 weight percent.

In one embodiment or in combination with any embodiment mentioned herein, the chemical recycling feedstock may comprise one or more PVB feed compositions having a residual PVOH content that is greater than 1 percent, greater than 2 percent, greater than 3 percent, greater than 4 percent, greater than 5 percent, or greater than 10 percent from a target residual PVOH content of regenerated PVB that is produced as described herein

In one embodiment or in combination with any embodiment mentioned herein, the PVB feed composition may comprise at least one plasticizer. For example, the PVB feed composition may comprise at least 1, at least 5, at least 10, at least 15, at least 20, at least 25, at least 30, at least 35, at least 40, at least 45, at least 50, at least 55, at least 60, at least 65, at least 70, at least 75, at least 80, at least 85, or at least 90 phr and/or not more than 100, not more than 90, not more than 85, not more than 80, not more than 75, not more than 70, not more than 65, not more than 60, not more than 55, not more than 50, not more than 45, not more than 40, not more than 35, not more than 30, not more than 25, not more than 20, not more than 15, not more than 10 phr, not more than 5, not more than 4, not more than 3, not more than 2, not more than 1, not more than 0.5, or not more than 0.1 of at least one plasticizer. As used herein, the term “parts per hundred parts of resin” or “phr” refers to the amount of plasticizer present as compared to one hundred parts of resin, on a weight basis.

In one embodiment or in combination with any embodiment mentioned herein, the chemical recycling feedstock may comprise at least two different PVB feed compositions including at least a first PVB feed composition and a second PVB feed composition, with the first PVB feed composition having a different plasticizer content relative to the second PVB feed composition. For example, the difference between the plasticizer content of the first PVB feed composition and the second PVB feed composition may be at least 2, at least 5, at least 10, at least 12, at least 15, at least 20, or at least 30 phr and/or not more than 15, not more than 13, not more than 11, not more than 9, not more than 8, not more than 6, not more than 5, not more than 4, not more than 3, not more than 2, not more than 1, not more than 0.5, or not more than 0.1 phr.

In one embodiment or in combination with any embodiment mentioned herein, the plasticizer can be triethylene glycol bis (2-ethylhexanoate) (“TEG-EH”), triethyleneglycol-di-2ethylbutyrate, triethylene glycol diheptanoate, tetraethylene glycol diheptanoate, tetraethylene glycol di-(2-ethylhexanoate) (“4GEH”), dioctyl adipate, hexyl cyclohexyladipate, diisononyl adipate, heptylnonyl adipate, di(butoxyethyl) adipate, dihexyladipate, dibutylsebacate, triethylene glycol di-(2-ethylhexanoate) (“3GEH”), dioctyl sebacate, bis-(2-methoxyethyl)terephthalate, bis-(butoxyethyl)terephthalate, bis-(butoxyethoxyethyl)terephthalate, bis-(ethoxyethyl)terephthalate, bis-(ethoxyethoxyethyl)terephthalate, bis-(2-ethylhexyloxyethyl)terephthalate, bis-(2-ethylhexyl)iso-phthalate, ethoxyethoxyethyl benzoate, butoxyethoxyethyl benzoate, butoxyethoxyethoxyethyl benzoate, dipropylene glycol di-o-toluate, or a combination of two or more thereof.

In one embodiment or in combination with any embodiment mentioned herein, the chemical recycling feedstock may comprise at least two different PVB feed compositions including at least a first PVB feed composition and a second PVB feed composition, with the first PVB feed composition having a different plasticizer relative to the second PVB feed composition. Alternatively, the first PVB feed composition and the second PVB feed composition may have the same plasticizer.

In one embodiment or in combination with any embodiment mentioned herein, the PVB feed composition may comprise less than 10, less than 5, less than 4, less than 3, less than 2, less than 1, or less than 0.5 weight percent of glass, frit, UV stabilizers, pigments, adhesion control agents, antioxidants, rubber, silicates, or a combination of two or more thereof, based on the total weight of the PVB feed composition.

In one embodiment or in combination with any embodiment mentioned herein, the PVB feed composition may comprise at least 0.01, at least 0.1, or at least 0.5 and/or less than 10, less than 5, less than 4, less than 3, less than 2, or less than 1 weight percent of glass, based on the total weight of the PVB feed composition.

Generally, the amount of solid contaminants in the PVB feed composition can be measured via an alcohol dissolution test where the PVB resin and plasticizer will dissolve in the designated alcohol, while the solid contaminants will not dissolve. In an embodiment or in combination with any embodiment mentioned herein, the PVB feed composition may comprise at least 0.01, at least 0.1, at least 0.2, at least 0.3, at least 0.4, at least 0.5, at least 1, at least 1.5, at least 2, at least 2.5, at least 3, at least 3.5, at least 4, at least 4.5, or at least 5 weight percent of one or more non-soluble components that are not soluble in an alcohol, based on the total weight of the PVB feed composition. Additionally, or in the alternative, the PVB feed composition may comprise less than 50, less than 40, less than 30, less than 25, less than 20, less than 15, less than 10, less than 9, less than 8, less than 7, less than 6, less than 5, less than 4, less than 3, less than 2, or less than 1 weight percent of one or more non-soluble components that are not soluble in an alcohol, based on the total weight of the PVB feed composition. Generally, the alcohol can be ethanol.

In one embodiment or in combination with any embodiment mentioned herein, the non-soluble components are not soluble in ethanol and may comprise glass, metal, a polymer, a salt, a silicate, calcium, a calcium derivative, a sodium derivative, or combinations thereof.

Generally, in one or more embodiments, the non-soluble components may comprise at least one polymer, such as polyolefin, a polyester, a rubber, a polyamide, a polystyrene, or a combination of two or more thereof. In an embodiment or in combination with any embodiment mentioned herein, the PVB feed composition may comprise at least 0.01, at least 0.1, at least 0.2, at least 0.3, at least 0.4, at least 0.5, at least 1, at least 1.5, at least 2, at least 2.5, at least 3, at least 3.5, at least 4, at least 4.5, or at least 5 weight percent of at least one non-soluble polymer. Additionally, or in the alternative, the PVB feed composition may comprise less than 50, less than 40, less than 30, less than 25, less than 20, less than 15, less than 10, less than 9, less than 8, less than 7, less than 6, less than 5, less than 4, less than 3, less than 2, or less than 1 weight percent of at least one non-soluble polymer. The polymers that are non-soluble in alcohol (e.g., ethanol) may be derived from packaging materials, recycled windshields, and/or mounting materials.

In one embodiment or in combination with any embodiment mentioned herein, the PVB feed composition may comprise at least 0.01, at least 0.1, at least 0.2, at least 0.3, at least 0.4, at least 0.5, at least 1, at least 1.5, at least 2, at least 2.5, at least 3, at least 3.5, at least 4, at least 4.5, or at least 5 weight percent of rubber. Additionally, or in the alternative, the PVB feed composition may comprise less than 50, less than 40, less than 30, less than 25, less than 20, less than 15, less than 10, less than 9, less than 8, less than 7, less than 6, less than 5, less than 4, less than 3, less than 2, or less than 1 weight percent of rubber.

In one embodiment or in combination with any embodiment mentioned herein, the PVB feed composition may comprise at least 0.01, at least 0.1, at least 0.2, at least 0.3, at least 0.4, at least 0.5, at least 1, at least 1.5, at least 2, at least 2.5, at least 3, at least 3.5, at least 4, at least 4.5, or at least 5 weight percent of glass, metal, a salt, a silicate, calcium, a calcium derivative, a sodium derivative, or combinations thereof. Additionally, or in the alternative, the PVB feed composition may comprise less than 50, less than 40, less than 30, less than 25, less than 20, less than 15, less than 10, less than 9, less than 8, less than 7, less than 6, less than 5, less than 4, less than 3, less than 2, or less than 1 weight percent of glass, metal, a salt, a silicate, calcium, a calcium derivative, a sodium derivative, or combinations thereof.

In one embodiment or in combination with any embodiment mentioned herein, the PVB feed composition may comprise less than 10, less than 5, less than 4, less than 3, less than 2, or less than 1 weight percent of glass, based on the total weight of the PVB feed composition.

The amount of non-soluble components in the PVB feed composition may be measured by combining 20 grams of the PVB feed composition with 200 mL of 190 proof ethanol in a stirred vessel and subjecting the mixture to stirring for four hours. The resulting solution is then screened with a strainer (12 to 30 mesh) and the screened solution is centrifuged at 4,200 rpm for 20 minutes. The supernatant is then poured into an aluminum tray and allowed to dry via evaporation in a ventilated hood until no weight loss is detectable. Subsequently, the material is further dried in an oven at 50° C. for two hours before it is pressed into a sheet at a thickness of 760 micron. The resulting sheet and precipitate are analyzed using a Bomem FT-NIR analyzer.

Additionally, or alternatively, the amount of solid contaminants may also be measured by ascertaining the ash content of the PVB feed compositions via ASTM D5630-13.

In one embodiment or in combination with any embodiment mentioned herein, the PVB feed composition may comprise at least 0.01, at least 0.1, at least 0.2, at least 0.3, at least 0.4, at least 0.5, at least 1, at least 1.5, at least 2, at least 2.5, at least 3, at least 3.5, at least 4, at least 4.5, or at least 5 weight percent of ash content as measured according to ASTM D5630-13, based on the total weight of the PVB feed composition. Additionally, or in the alternative, the PVB feed composition may comprise less than 50, less than 40, less than 30, less than 25, less than 20, less than 15, less than 10, less than 9, less than 8, less than 7, less than 6, less than 5, less than 4, less than 3, less than 2, less than 1, or less than 0.5 weight percent of ash content as measured according to ASTM D5630-13, based on the total weight of the PVB feed composition.

Examples of suitable PVB feed compositions for use in the chemical recycling facility described herein can include, but are not limited to, post-industrial or post-consumer recycle material, such as post-industrial PVB feed scrap and/or post-consumer PVB feed scrap. Exemplary post-industrial PVB feed compositions can include, for example, PVB scrap, cracked laminated glass, off-grade PVB resin, over-sized material from PVB production, or a combination of two or more thereof.

Specific embodiments of PVB feed compositions (in the form of interlayers) are described in detail in PCT Patent Application Publication No. WO 2021/127206 and U.S. Patent Application Publication No. 2017/0285339, the entireties of which are incorporated herein by reference to the extent not inconsistent with the present disclosure.

Generally, the formulation of the PVB feed composition may vary over time depending on the source of the PVB feed composition. For example, the amount of the PVB resin, the plasticizer, and/or the solid contaminants (e.g., glass, rubber, etc.) may vary with each PVB feed composition introduced into the chemical recycling facility.

In one embodiment or in combination with any embodiment mentioned herein, one or more of the following criteria may be applicable to the PVB feed composition being introduced into chemical recycling facility 100: (i) the amount of the PVB resin in the PVB feed composition varies by at least 2 weight percent over time, (ii) the amount of the plasticizer in the PVB feed composition varies by at least 2 phr over time, (iii) the amount of the solid contaminants in the PVB feed composition varies by at least 2 weight percent over time, or (iv) the ratio of the PVB resin to the plasticizer varies by at least 2 percent by weight over time. In many cases, at least two, at least three, or all four of the criteria are met. This can be due to the variance of the source that the PVB feed composition is derived from.

As discussed above, the composition of the PVB feed composition being fed into the chemical recycling facility may vary depending on its source. However, the chemical recycling facility may be designed so as to facilitate this variance in the PVB feed composition.

In one embodiment or in combination with any embodiment mentioned herein, the amount of the PVB resin in the PVB feed composition varies by at least 2, at least 3, at least 4, at least 5, at least 6, at least 7, at least 8, at least 9, at least 10, at least 11, at least 12, at least 13, at least 14, or at least 15 weight percent and/or less than 25 weight percent over a time period of 1 hour, 6 hours, 12 hours, 18 hours, 1 day, 2 days, 3 days, 4 days, or one week. As noted above, this difference can be calculated based on the difference between two given weight percentages at the designated time period, calculated by subtracting one number from the other.

In one embodiment or in combination with any embodiment mentioned herein, the amount of the plasticizer in the PVB feed composition varies by at least 2, at least 3, at least 4, at least 5, at least 6, at least 7, at least 8, at least 9, at least 10, at least 11, at least 12, at least 13, at least 14, or at least 15 phr and/or less than 25 phr over a time period of 1 hour, 6 hours, 12 hours, 18 hours, 1 day, 2 days, 3 days, 4 days, or one week. As noted above, this difference can be calculated based on the difference between two given phr values at the designated time period, calculated by subtracting one number from the other.

In one embodiment or in combination with any embodiment mentioned herein, the amount of the solid contaminants in the PVB feed composition varies by at least 2, at least 3, at least 4, at least 5, at least 6, at least 7, at least 8, at least 9, at least 10, at least 11, at least 12, at least 13, at least 14, or at least 15 weight percent and/or less than 25 weight percent over a time period of 1 hour, 6 hours, 12 hours, 18 hours, 1 day, 2 days, 3 days, 4 days, or one week. As noted above, this difference can be calculated based on the difference between two given weight percentages at the designated time period, calculated by subtracting one number from the other.

In one embodiment or in combination with any embodiment mentioned herein, the ratio of the PVB resin to the plasticizer in the PVB feed composition varies by at least 2, at least 3, at least 4, at least 5, at least 6, at least 7, at least 8, at least 9, at least 10, at least 11, at least 12, at least 13, at least 14, or at least 15 percent and/or less than 25 percent over a time period of 1 hour, 6 hours, 12 hours, 18 hours, 1 day, 2 days, 3 days, 4 days, or one week. As noted above, this difference can be calculated based on the difference between two given ratio values at the designated time period, calculated by subtracting one number from the other.

The above variance measurements can be measured by sampling the PVB feed composition at the designated time periods (e.g., at one week). To create consistent measurements, a 20-gram sample of the PVB feed composition may be obtained and tested as discussed above via the solubility analysis.

Referring still to FIGS. 1 and 2, PVB feedstock 102 may be subjected to a size reduction operation at unit 104. The size-reduction operation reduces the particle size of the PVB feed composition prior to hydrolysis thereof, as described above. Such size-reduction can be provided by, for example, grinding/granulating, shredding, guillotining, chopping, or other comminuting processes that provide PVB-containing composition particles having a reduced size. Such mechanical size reduction operations can include a size reduction step other than crushing and/or compacting.

In one embodiment, unit 104 reduces the average particle size of individual fragments of PVB feedstock 102 by at least 10, at least 25, at least 50, or at least 75 percent of their original size. Additionally or alternatively, unit 104 reduces the average particle size of individual fragments of PVB feedstock 102 to an average particle size of less than about 400 microns, 350 microns, 300 microns, or 250 microns, or between about 200 and about 400 microns, between about 225 microns and about 375 microns, or between about 250 microns and about 350 microns. Additionally or alternatively, such as when PVB feedstock 102 includes interlayer scrap, unit 104 reduces the average particle size of individual fragments of PVB feedstock 102 to “flakes” having dimensions of less than 10 mm by 10 mm, 8 mm by 8 mm, 6 mm by 6 mm, or 5 mm by 5 mm.

In some embodiments, size-reduced PVB 106 discharged from unit 104 is optionally washed and then optionally processed to extract plasticizer therefrom in units 108 and 110, respectively. For example, in embodiments where the PVB feed composition is derived from post-consumer recycle material, such as PVB flappers obtained from glass recyclers, unit 104 pre-washes size-reduced PVB 106 to remove non-soluble components therefrom. The pre-washing step may reduce the ash content of the PVB to less than about 0.5 percent, about 0.4 percent, about 0.3 percent, about 0.2 percent, or about 0.1 percent by weight of the PVB feed composition. The pre-washing step may also reduce the iron content of the PVB to less than about 50 ppm, about 40 ppm, about 30 ppm, about 20 ppm, about 10 ppm, or about 5 ppm.

At unit 108, size-reduced PVB 106 is suspended in water and stirred for a duration. The temperature of the water may be within a range between about 10 and about 100° C., between about 20 and about 90° C., between about 25 and about 75° C., or between about 40 and about 60° C., and the PVB suspension stirred for a duration of at least 15 minutes, at least 30 minutes, at least 45 minutes, or at least 1 hour. In some embodiments, one or more metal sequestering agents may be introduced into unit 108 to facilitate the recovery of contaminants from the suspension. Example metal sequestering agents include, but are not limited to, citric acids, ethylenediaminetetraacetic acid (EDTA), and the like.

In addition, the pH of the suspension may be maintained at acidic levels to neutralize any base that is left on, for example, a PVB flapper obtained from a glass removing step. The pH of the suspension may be maintained at less than about 7, less than about 6, less than about 5, less than about 4, less than about 3, less than about 2, or less than about 1, or between about 0 and about 5, between about 0 and about 4, between about 0 and about 3, between about 1 and about 2, or between about 1.5 and about 2. Upon passage of the stirring duration, the PVB may be filtered, rinsed on the filter with additional water to remove residual acid, and discharged from unit 108 as washed PVB 112.

At unit 110, plasticizer is extracted from washed PVB 112. This optional plasticizer extraction step may be performed in embodiments where the PVB feed composition is derived from low quality post-industrial PVB interlayer scrap, for example. In such instances, plasticizer is extracted from washed PVB 112 prior to the hydrolysis step to enable the hydrolysis to be performed in an efficient manner. In some embodiments, the plasticizer extraction step is performed with supercritical carbon dioxide, or is performed by suspending washed PVB 112 in an extraction solution. The extraction solution may include water, alcohol, and combinations thereof in varying proportions. Example alcohols include, but are not limited to, methanol, ethanol, and isopropanol.

The number of stages of extraction to be performed may be based on extraction time, extraction temperature, and/or the polymer loading of the solution. For example, the extraction time may be a duration of at least 10 minutes, at least 30 minutes, at least 1 hour, at least 2 hours, at least 3 hours, or at least 4 hours. The extraction temperature may be at least 10° C., at least 20° C., at least 30° C., or at least 40° C. Thus, based on these factors, at least 1, at least 2, at least 3, or at least 4 extraction stages may be performed to reduce the phr of the PVB to less than about 25, less than about 20, less than about 15, less than about 10, less than about 5, less than about 4, less than about 3, less than about 2, or less than about 1.

Following the plasticizer extraction, the mixture of washed PVB 112 and the extraction solution may be filtered, and the filtrate dried via evaporation of volatile material, to obtain dried PVB 114. Such volatile material may be recovered, such as by distillation, and the plasticizer, alcohol, and/or water can be recycled for further use. Dried PVB 114 obtained from the plasticizer extraction step may be inspected to verify the average particle size thereof is less than about 400 microns, 350 microns, 300 microns, or 250 microns, or between about 200 and about 400 microns, between about 225 microns and about 375 microns, or between about 250 microns and about 350 microns. Further size reduction may be performed, if necessary, to reduce the size of dried PVB 114 to the average particle sizes described above. In an alternative embodiment, unit 108 is located after the washing and plasticizer extraction steps.

Referring to FIG. 1, dried PVB 114 is hydrolyzed in unit 116 to produce a solution 118 comprising a number of hydrolyzed products in the form of recycled content products, which were directly derived from the PVB-containing composition. For example, the hydrolyzed products may comprise several recycled content products derived from the hydrolysis of the PVB resin, as will be described in more detail below. In the illustrated embodiment, dried PVB 114 may be hydrolyzed in the presence of water 120, alcohol 122, and, optionally, an acid catalyst 124 to produce solution 118 comprising regenerated PVOH, and a vapor stream 126.

Alternatively, in the embodiment illustrated in FIG. 2, dried PVB 114 may be dissolved in alcohol 122 prior to performance of the hydrolysis step. For example, dried PVB 114 may be fed to a dissolution and filtration unit 128 where dried PVB 114 is mixed with a solvent, such as alcohol 122, for a residence time that facilitates dissolution of dried PVB 114 into alcohol 122 to produce a PVB solution 130. In some embodiments, dissolving dried PVB 114 in the solvent facilitates the identification of any remaining non-soluble contaminants in the PVB feed composition leftover from the washing and/or plasticizer extraction steps. Any remaining contaminants may be filtered and removed from the resulting solution at unit 128 prior to being fed to unit 116.

PVB solution 130 fed to unit 116 is hydrolyzed, as will be described in more detail below. Dried PVB 114 may be completely or partially dissolved prior to being fed to unit 116. For example, PVB solution 130 may have a total solids content of less than about 25 percent, less than about 20 percent, less than about 15 percent, less than about 10 percent, less than about 5 percent, less than about 2.5 percent, or less than about 1 percent by weight of the solution.

As a result of the hydrolysis reaction, the PVB is generally converted to PVOH and butyraldehyde, for example. The regenerated PVOH is generally soluble and is thus recovered in solution (i.e., liquid form), and the regenerated butyraldehyde is reactively distilled (i.e., vaporized) from the solution. Accordingly, r-PVOH solution 118 may comprise the regenerated PVOH, water, and polyvinyl acetate (PVAC), alcohol, catalyst, butyraldehyde, and/or butyral in residual amounts. In addition, vapor stream 126 may comprise the regenerated butyraldehyde and alcohol.

The extent of hydrolysis achieved (i.e., the conversion rate of PVB to PVOH) may be based on factors such as the presence of an acid catalyst, the concentration of the acid catalyst if present, reaction time, polymer loading, resin composition, and reaction temperature. It is believed, without being bound by any particular theory, that hydrolyzed PVB is soluble when its PVOH content is greater than a PVOH content threshold. Accordingly, converted PVOH may be in the form of water-insoluble PVB resin having a higher residual PVOH content, and/or a decreased butyraldehyde content, than the PVB resin. The converted PVOH may also be in the form of water-soluble PVOH (i.e., PVB hydrolyzed to greater than the PVOH content threshold).

In one embodiment or in combination with any embodiment mentioned herein, the water-insoluble PVB of the reaction product has a residual PVOH content, of less than 90 percent, less than 80 percent, less than 70 percent, less than 60 percent, less than 50 percent, less than 40 percent, less than 30 percent, between 20 percent and 90 percent, between 30 percent and 90 percent, between 40 percent and 90 percent, between 50 percent and 90 percent, between 50 percent and 80 percent, or between 50 percent and 70 percent. In other words, water-soluble PVOH has a residual PVOH content of greater than 90 percent, greater than 95 percent, greater than 98 percent, greater than 99 percent, or 100 percent.

In the example embodiments, the aforementioned hydrolysis factors may be adjusted to obtain an average PVB to PVOH conversion rate of at least 80 percent, at least 85 percent, at least 90 percent, at least 95 percent, at least 99 percent, between 80 percent and 99 percent, between 85 percent and 99 percent, between 90 percent and 99 percent, or between 95 percent and 99 percent.

Accordingly, in one embodiment, the resulting r-PVOH solution 118 comprises water, PVOH, and a remainder of one or more additional components. The concentration of water in r-PVOH solution 118 may be at least 80 percent, at least 85 percent, at least 90 percent, at least 95 percent, at least 98 percent, at least 99 percent, or between 80 percent and 99 percent, between 85 percent and 99 percent, between 90 and 99 percent, or between 95 and 99 percent by weight of r-PVOH solution 118.

The concentration of water-soluble PVOH in r-PVOH solution 118 may be less than 20 percent, less than 15 percent, less than 10 percent, less than 5 percent, less than 2 percent, less than 1 percent, or between 1 percent and 20 percent, between 1 percent and 15 percent, between 1 percent and 10 percent, or between 1 percent and 5 percent by weight of r-PVOH solution 118.

The concentration of the remainder may be less than 20 percent, less than 15 percent, less than 10 percent, less than 5 percent, less than 2 percent, less than 1 percent, or between 1 percent and 20 percent, between 1 percent and 15 percent, between 1 percent and 10 percent, or between 1 percent and 5 percent by weight of r-PVOH solution 118.

The remainder may include residual polyvinyl acetate (PVAC), residual alcohol, residual catalyst, butyraldehyde, and/or butyral. These concentration of these remainders may each comprise less than 5 percent, less than 2 percent, less than 1 percent, less than 0.5 percent, or less than 0.1 percent by weight of r-PVOH solution 118.

As described above, conversion of PVB to PVOH may be based on a variety of factors. In one embodiment or in combination with any embodiment mentioned herein, the hydrolysis step is performed at a temperature within a range between about 70° C. and about 250° C. In general, the hydrolysis may be performed at lower temperatures within this range when done so in the presence of acid catalyst 124. For example, hydrolysis performed in the presence of acid catalyst 124 may occur at a temperature within a range between about 70° C. and about 150° C., between about 70° C. and about 140° C., between about 75° C. and about 130° C., or between about 80° C. and about 120° C. Example acid catalysts include, but are not limited to, organic sulfonic acid, nitric acid, sulfuric acid, or hydrochloric acid.

Alternatively, the hydrolysis may be performed at comparatively higher temperatures within the range described above when the hydrolysis does not occur in the presence of acid catalyst 124. For example, hydrolysis that is not performed in the presence of acid catalyst 124 may occur at a temperature within a range between about 150° C. and about 250° C., between about 160° C. and about 225° C., between about 170° C. and about 220° C., or between about 175° C. and about 200° C.

In one embodiment or in combination with any embodiment mentioned herein, the hydrolysis step is performed for a reaction time of at least 30 minutes, at least 1 hour, at least 2 hours, at least 4 hours, at least 8 hours, at least 16 hours, at least 32 hours, or at least 64 hours.

In one embodiment or in combination with any embodiment mentioned herein, when present, the concentration of the acid catalyst in the PVB hydrolysis solution (e.g., the mixture of dried PVB 114 or PVB solution 130, water 120, alcohol 122, and acid catalyst 124) is less than about 15 percent, 10 percent, less than about 8 percent, less than about 5 percent, less than about 4 percent, less than about 3 percent, less than about 2 percent, less than about 1 percent, less than about 0.5 percent, less than about 0.1 percent, between about 0.5 percent and about 10 percent, between about 0.5 percent and about 8 percent, between about 0.5 percent and about 5 percent, between about 1 percent and about 5 percent, or between about 2 percent and about 4 percent by weight of the hydrolysis solution.

In some embodiments, vapor stream 126 discharged from unit 116 may be channeled to a distillation/separation unit 132. As described above, vapor stream 126 includes a mixture of regenerated butyraldehyde and alcohol. Unit 132 is operable to separate this mixture into its component parts, such that alcohol 134 and regenerated butyraldehyde 136 are discharged from unit 132 as separate streams. Alcohol 134 may be recycled for use in unit 116 (FIG. 1) or unit 128 (FIG. 2), and regenerated butyraldehyde 136 may be stored and/or channeled for use in a unit downstream from unit 116, as will be described in more detail below.

In addition to residual PVAC, residual alcohol, residual catalyst, butyraldehyde, and/or butyral, r-PVOH solution 118 may also comprise one or more non-soluble components that remain from the PVB washing step at unit 108, and/or that were produced in the hydrolysis reaction. Example non-soluble components include, but are not limited to, undissolved PVOH (e.g., water-insoluble PVB), debris, dirt, cross-linked polymer particles, gelled particles, metallic particles, ceramic material, rubber material, adhesive material, and polyurethane. Thus, r-PVOH solution 118 discharged from unit 116 may be optionally filtered in unit 138, and/or centrifuged in unit 140, to produce a filtered r-PVOH solution 142 that is substantially free of these non-soluble components. For example, the filtration/centrifugation step(s) may be defined by a particle size retention of less than about 5 microns, less than about 4 microns, less than about 3 microns, less than about 2 microns, or less than about 1 micron.

A portion of the resulting filtered r-PVOH solution 142 may be recovered and stored for future use. In addition, in the illustrated embodiment, a portion of the resulting filtered r-PVOH solution 142 may also be used to produce regenerated PVB in chemical recycling facility 100. In one embodiment or in combination with any embodiment mentioned herein, r-PVOH solution 142 is cooled in unit 144 and then used to produce r-PVB 146 at unit 148. At unit 144, r-PVOH solution 142 may be cooled to less than 150° C., less than 125° C., less than 100° C., less than 75° C., less than 50° C., less than 25° C., less than 15° C., less than 10° C., between 10° C. and 150° C., between 10° C. and 125° C., between 10° C. and 100° C., between 15° C. and 75° C., or between 25° C. and 50° C. Thus, r-PVOH solution 142 is cooled to a temperature conducive to PVB production at unit 148.

At unit 148, r-PVOH solution 142 is combined with water 150 and butyraldehyde, optionally in the presence of acid catalyst 124, to produce r-PVB 146. The butyraldehyde may be sourced as fresh butyraldehyde 152 and/or as r-butyraldehyde 136 recycled from unit 132. Fresh PVOH 154 may also be fed to unit 148 to produce r-PVB 146.

As used herein, “fresh” refers to a constituent provided from a source other than the PVB hydrolysis reactions described herein. For example, the constituent may be purchased or produced in a separate industrial process.

In one embodiment or in combination with any embodiment mentioned herein, r-PVB 146 is inspected at unit 156 for defects, including at least one of oversizing, visual defects, compositional defects, gelling, or contamination. PVB produced from the reaction of water, PVOH, and butyraldehyde is generally defined herein as “on-spec” and “off-spec” based on inspection for such defects. On-spec PVB does not have any of the defects described above. Off-spec PVB has at least one defect described above. At unit 156, on-spec PVB 158 is separated from off-spec PVB 160 based on the inspection. On-spec PVB 158 is discharged from unit 156 and recovered. In the illustrated embodiment, off-spec PVB 160 is discharged from unit 156, optionally size reduced at unit 162 if oversized, and channeled to unit 116 to produce additional regenerated PVOH therefrom.

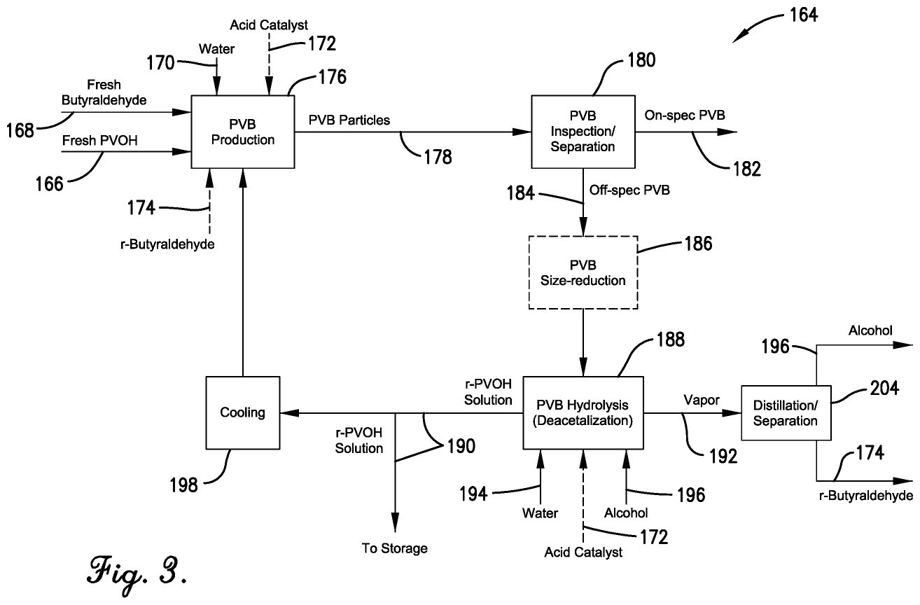

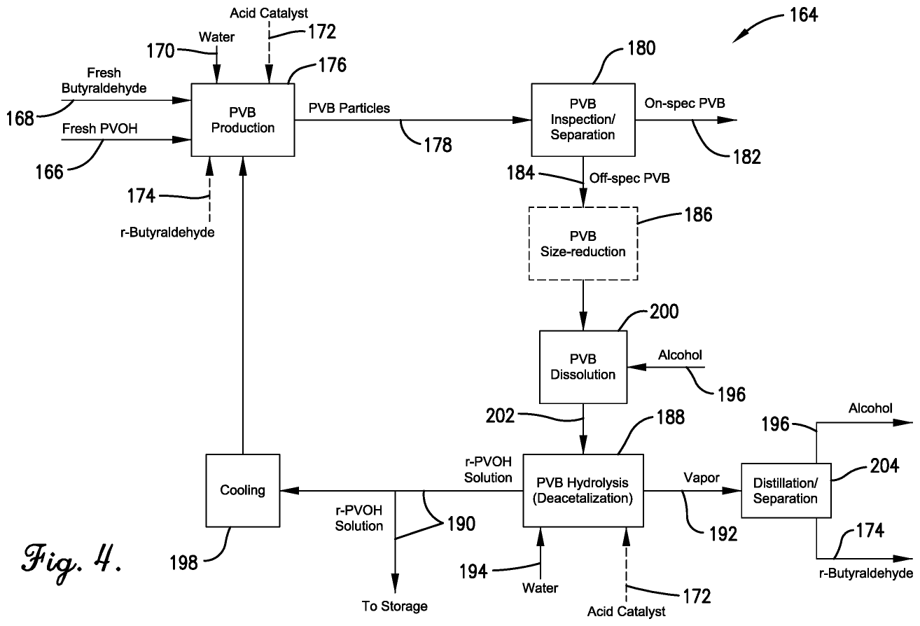

Referring now to FIGS. 3 and 4, a chemical recycling facility 164 is designed to produce PVB particles from the reaction of fresh raw constituents, and processing (i.e., hydrolyzing) any off-spec PVB particles to produce regenerated PVOH that may be used in the production of additional PVB particles. In the example illustrations, fresh PVOH 166, fresh butyraldehyde 168, water 170, and optionally an acid catalyst 172 (e.g., acid catalyst 124) and r-butyraldehyde 174 are combined in a unit 176 to produce PVB particles 178.

In one embodiment or in combination with any embodiment mentioned herein, PVB particles 178 are inspected at unit 180 for defects, including at least one of oversizing, visual defects, compositional defects, gelling, or contamination. At unit 180, on-spec PVB 182 is separated from off-spec PVB 184 based on the inspection. On-spec PVB 182 is discharged from unit 180 and recovered. Off-spec PVB 184 is discharged from unit 180, optionally size reduced in unit 186 based on the process conditions associated with unit 104 (shown in FIGS. 1 and 2), and channeled to unit 188 to produce r-PVOH therefrom.

Referring to FIG. 3, off-spec PVB 184 is hydrolyzed at unit 188 to produce a solution 190 comprising regenerated PVOH, and a vapor stream 192. Off-spec PVB 184 may be hydrolyzed in the presence of water 194, alcohol 196, and, optionally, acid catalyst 172 to produce r-PVOH solution 190. The hydrolysis is performed in accordance with the process conditions associated with unit 116 (shown in FIGS. 1 and 2), as described above.

A portion of the resulting r-PVOH solution 190 may be recovered and stored for future use. In addition, in the illustrated embodiment, a portion of r-PVOH solution 190 may also be used to produce regenerated PVB particles in chemical recycling facility 164. In one embodiment or in combination with any embodiment mentioned herein, r-PVOH solution 190 is cooled in unit 198 and then used to produce additional PVB particles 178 in unit 176.

Alternatively, in the embodiment illustrated in FIG. 4, off-spec PVB 184 may be dissolved in alcohol 196 prior to performance of the hydrolysis step. For example, off-spec PVB 184 may be fed to a dissolution unit 200 where off-spec PVB 184 is mixed with a solvent, such as alcohol 196, for a residence time that facilitates dissolution of off-spec PVB 184 into alcohol 196 to produce a PVB solution 202. PVB solution 202 may then be fed to unit 188 and hydrolyzed, as described above. Off-spec PVB 184 may be completely or partially dissolved prior to being fed to unit 188.

Referring again to FIGS. 3 and 4, vapor stream 192 discharged from unit 188 may be channeled to a distillation/separation unit 204. Vapor stream 192 includes a mixture of regenerated butyraldehyde and alcohol. Unit 204 is operable to separate this mixture into its component parts, such that alcohol 196 and regenerated butyraldehyde 174 are discharged from unit 204 as separate streams. Alcohol 196 may optionally be recycled for use in unit 188 (FIG. 3) or unit 200 (FIG. 4), and regenerated butyraldehyde 174 may be stored and/or channeled for use in the production of PVB particles 178 at unit 176, as described above.

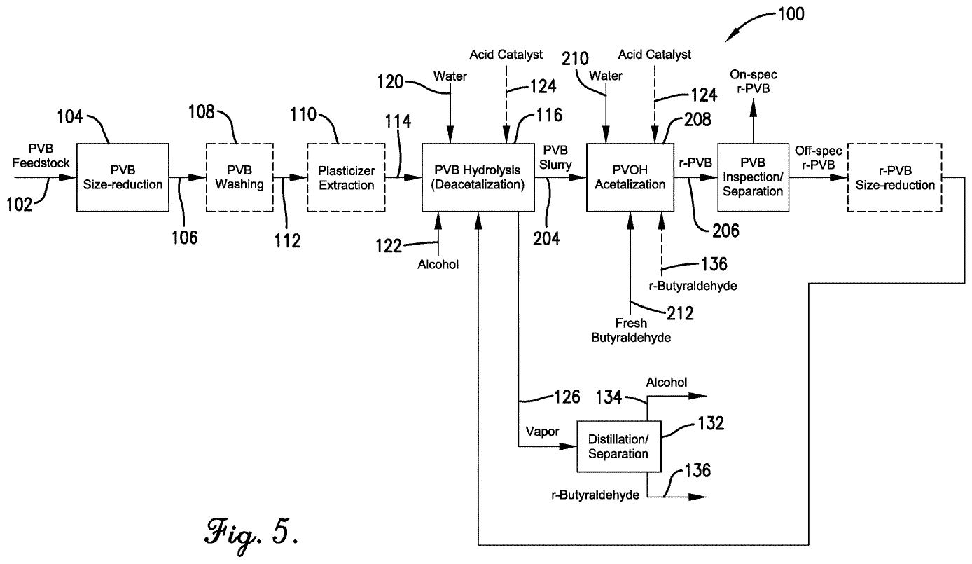

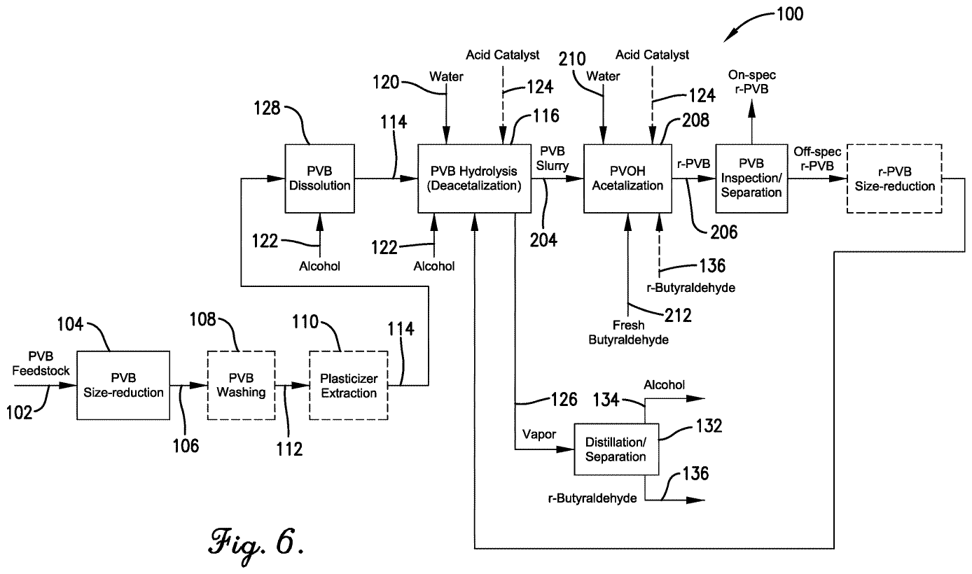

Referring now to FIGS. 5 and 6, dried PVB 114 is partially hydrolyzed at unit 116 to produce a reaction product comprising a number of hydrolyzed products in the form of recycled content products, which were directly derived from the PVB-containing composition. For example, the hydrolyzed products may comprise several recycled content products derived from the hydrolysis of the PVB resin, as described above. In the illustrated embodiment, dried PVB 114 may be hydrolyzed in the presence of water 120, alcohol 122, and, optionally, acid catalyst 124 to produce the reaction product comprising water-insoluble PVB having a higher residual PVOH content than the PVB resin, and vapor stream 126. As will be described in more detail below, partial hydrolysis of the PVB-containing composition limits the solubility of the PVB such that the reaction product is in the form of a PVB slurry 204 of insoluble PVB, for example, in liquid discharged from unit 116.

The extent of hydrolysis achieved (i.e., the conversion rate of PVB to PVOH) at unit 116, for example, is controllable by adjusting factors such as the presence of an acid catalyst, the concentration of the acid catalyst if present, reaction time, polymer loading, resin composition, and reaction temperature. It is believed, without being bound by any particular theory, that hydrolyzed PVB is soluble when its PVOH content is greater than a PVOH content threshold. Accordingly, converted PVOH may be in the form of water-insoluble PVB resin having a higher residual PVOH content, and/or a decreased butyraldehyde content, than the PVB resin. The converted PVOH may also be in the form of water-soluble PVOH (i.e., PVB hydrolyzed to greater than the PVOH content threshold).

In the embodiments illustrated in FIGS. 5-10, the aforementioned hydrolysis factors are adjusted to produce a reaction product that is partially hydrolyzed. As used herein, “partial hydrolysis” refers to a process that hydrolyzes PVB to produce a reaction product comprising water-insoluble PVB. Partial hydrolysis may be defined by a reduction in PVB content (i.e., from the conversion of water-insoluble PVB to water-soluble PVOH) of the PVB feed composition by at least 10 percent, at least 20 percent, at least 30 percent, at least 40 percent, at least 50 percent, at least 60 percent, at least 70 percent, at least 80 percent, at least 90 percent, or up to 100 percent by weight of its starting PVB content. Alternatively, partial hydrolysis may be defined by a reduction in the acetal content of the PVB feed composition by at least 10 percent, at least 20 percent, at least 30 percent, at least 40 percent, at least 50 percent, at least 60 percent, at least 70 percent, at least 80 percent, at least 90 percent, or up to 100 percent by weight of its starting acetal content. Accordingly, the partial hydrolysis produces a reaction product that includes one or both of water-insoluble PVB and water-soluble PVOH.

In one embodiment or in combination with any embodiment mentioned herein, the water-insoluble PVB of the reaction product has a residual PVOH content, of less than 90 percent, less than 80 percent, less than 70 percent, less than 60 percent, less than 50 percent, less than 40 percent, less than 30 percent, between 20 percent and 90 percent, between 30 percent and 90 percent, between 40 percent and 90 percent, between 50 percent and 90 percent, between 50 percent and 80 percent, or between 50 percent and 70 percent. In other words, water-soluble PVOH has a residual PVOH content of greater than 90 percent, greater than 95 percent, greater than 98 percent, greater than 99 percent, or 100 percent.

In one embodiment or in combination with any embodiment mentioned herein, the partial hydrolysis step is performed at a temperature within a range between about 70° C. and about 250° C. In general, the hydrolysis may be performed at lower temperatures within this range when done so in the presence of acid catalyst 124. For example, hydrolysis performed in the presence of acid catalyst 124 may occur at a temperature within a range between about 70° C. and about 150° C., between about 70° C. and about 140° C., between about 75° C. and about 130° C., or between about 80° C. and about 120° C. Example acid catalysts include, but are not limited to, organic sulfonic acid, nitric acid, sulfuric acid, or hydrochloric acid.

Alternatively, the hydrolysis may be performed at comparatively higher temperatures within the range described above when the hydrolysis does not occur in the presence of acid catalyst 124. For example, hydrolysis that is not performed in the presence of acid catalyst 124 may occur at a temperature within a range between about 150° C. and about 250° C., between about 160° C. and about 225° C., between about 170° C. and about 220° C., or between about 175° C. and about 200° C.

In one embodiment or in combination with any embodiment mentioned herein, the hydrolysis step is performed for a reaction time of at least 30 minutes, at least 1 hour, at least 2 hours, at least 4 hours, at least 8 hours, at least 16 hours, at least 32 hours, or at least 64 hours.

Referring again to FIGS. 5-7, the reaction product discharged from unit 116 is in the form of PVB slurry 204, which includes water-insoluble PVB and water. In one embodiment or in combination with any embodiment mentioned herein, PVB slurry 204 comprises less than 25 percent, less than 20 percent, less than 15 percent, less than 10 percent, less than 5 percent, between 0 percent and 25 percent, between 1 percent and 25 percent, between 5 percent and 25 percent, or between 10 percent and 20 percent water-insoluble PVB by weight. Further, in one embodiment or in combination with any embodiment mentioned herein, PVB slurry 204 comprises greater than 25 percent, greater than 50 percent, greater than 75 percent, between 25 percent and 75 percent, between 30 percent and 70 percent, between 35 percent and 65 percent, or between 40 percent and 60 percent water by weight.

In the illustrated embodiments, PVB slurry 204 is used to produce r-PVB 206 at unit 208. Specifically, at unit 208, PVB slurry 204 is combined with water 210 and butyraldehyde, optionally in the presence of acid catalyst 124, to produce r-PVB 206. That is, the residual PVOH of the water-insoluble PVB in PVB slurry 204 is reacted with butyraldehyde to produce r-PVB 206. The butyraldehyde may be sourced as fresh butyraldehyde 212 and/or as regenerated butyraldehyde 136 recycled from unit 132.

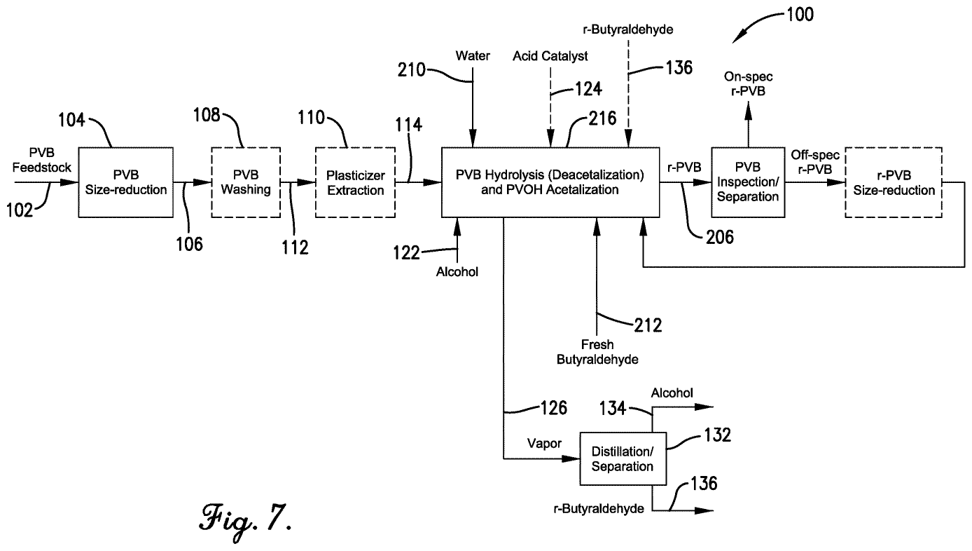

As illustrated in FIGS. 5 and 6, the partial hydrolysis and PVOH acetalization (reacting) steps are performed in separate units 116 and 208, respectively. Alternatively, in the embodiment illustrated in FIG. 7, the partial hydrolysis and PVOH acetalization steps are performed in the same unit 216. For example, partial hydrolysis of dried PVB 114 may be performed in unit 216 as described above. After the PVB is converted to a desired extent, one or more of fresh butyraldehyde 212 or regenerated butyraldehyde 136 may be fed to unit to produce r-PVB 206 therefrom.

PVOH acetalization reduces the PVOH content in the PVB, such that r-PVB 206 has a lower residual PVOH content than the water-insoluble PVB. In some embodiments, the PVOH acetalization is controlled to achieve a target residual PVOH content in r-PVB 206. In one embodiment or in combination with any embodiment mentioned herein, the r-PVB produced has a residual PVOH content (e.g., the target residual PVOH content) of between 1 percent and 90 percent, between 5 percent and 30 percent, between 7 percent and 30 percent, or between 16 percent and 20 percent.

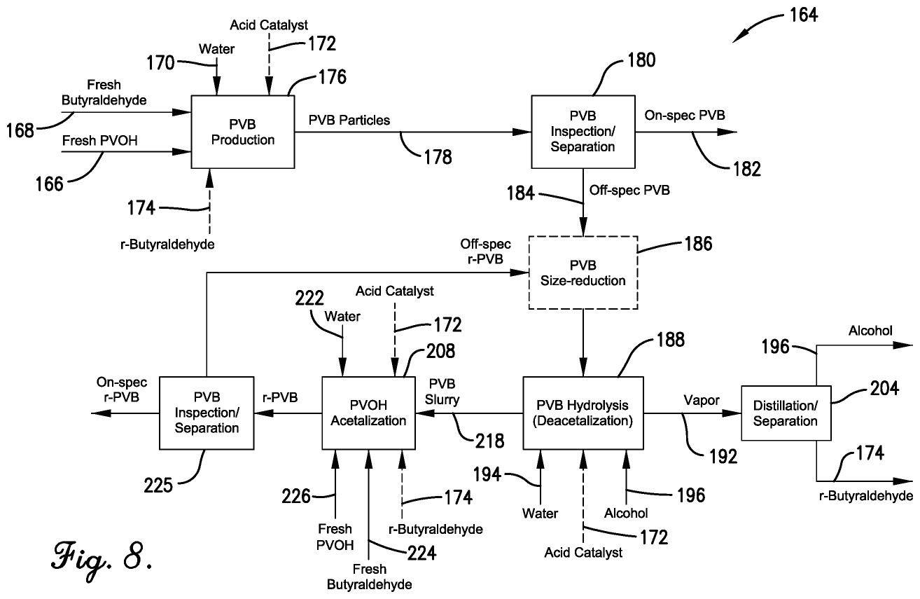

Referring now to FIGS. 8-10, PVB particles 178 are produced from the reaction of fresh raw constituents, such as fresh PVOH 166 and fresh butyraldehyde 168, as well as water 170, optionally acid catalyst 124, and r-butyraldehyde 174. In one embodiment or in combination with any embodiment mentioned herein, PVB particles 178 are inspected at unit 180 for defects. On-spec PVB 182 is separated from off-spec PVB 184 based on the inspection.

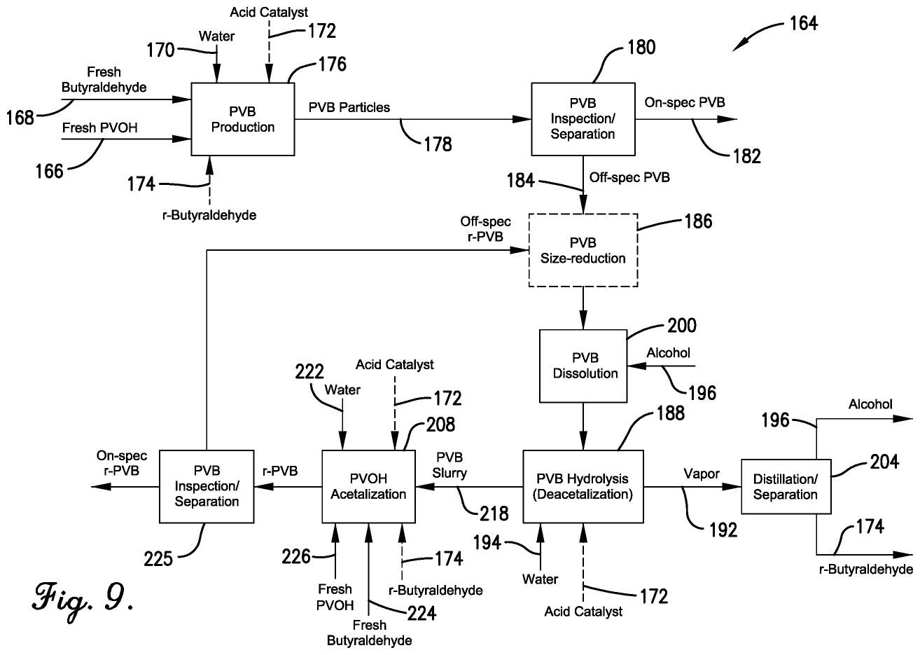

Referring to FIGS. 8 and 9, off-spec PVB 184 is partially hydrolyzed at unit 188 to produce a reaction product comprising a number of hydrolyzed products in the form of recycled content products, which were directly derived from the PVB-containing composition. For example, the hydrolyzed products may comprise several recycled content products derived from the hydrolysis of the PVB resin, as described above. In the illustrated embodiment, off-spec PVB 184 may be hydrolyzed in the presence of water 120, alcohol 122, and, optionally, acid catalyst 124 to the reaction product comprising water-insoluble PVB having a higher residual PVOH content than the PVB resin, and vapor stream 192. As described above, the solubility of partially hydrolyzed PVB is based on the extent of the hydrolysis performed on the PVB-containing composition. Thus, in some embodiments, the reaction product is in the form of a PVB slurry 218 discharged from unit 116.

In the illustrated embodiments, PVB slurry 218 is used to produce r-PVB 220 at unit 208. Specifically, at unit 208, PVB slurry 218 is combined with water 222 and butyraldehyde, optionally in the presence of acid catalyst 124, to produce r-PVB 220. That is, the residual PVOH of the water-insoluble PVB in PVB slurry 218 is reacted with butyraldehyde to produce r-PVB 220. The butyraldehyde may be sourced as fresh butyraldehyde 224 and/or as regenerated butyraldehyde 174 recycled from unit 204.

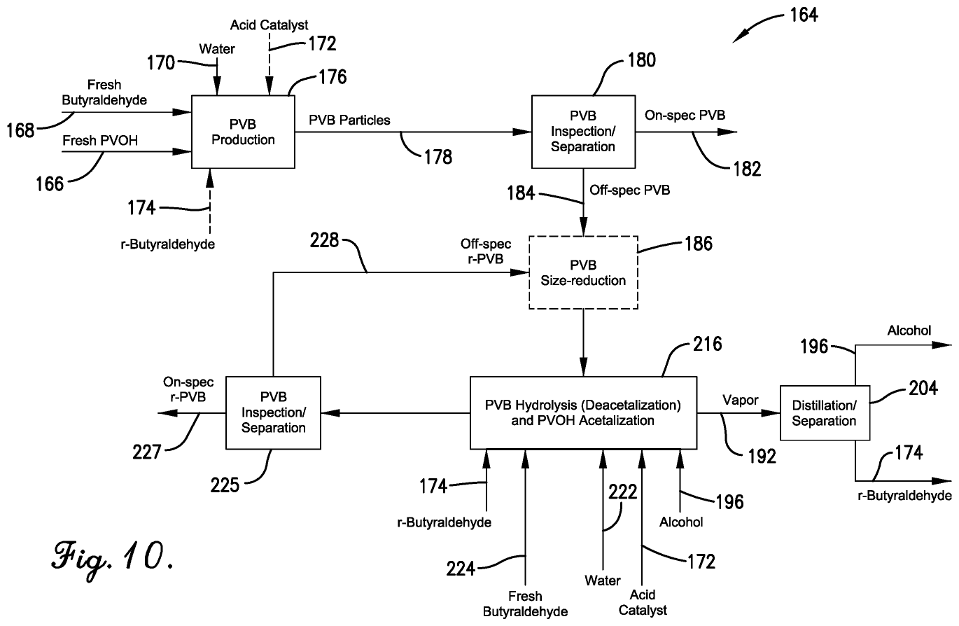

As illustrated in FIGS. 8 and 9, the partial hydrolysis and PVOH acetalization (reacting) steps are performed in separate units 188 and 208, respectively. Alternatively, in the embodiment illustrated in FIG. 10, the partial hydrolysis and PVOH acetalization steps are performed in the same unit 216. For example, partial hydrolysis of off-spec PVB 184 may be performed in unit 216 as described above. After the PVB is converted to a desired extent, one or more of fresh butyraldehyde 224 or regenerated butyraldehyde 174 may be fed to unit 216 to produce r-PVB 220 therefrom.

In one embodiment or in combination with any embodiment mentioned herein, r-PVB 220 is inspected at an inspection unit 225 for defects, including at least one of oversizing, visual defects, compositional defects, gelling, or contamination. At unit 225, on-spec PVB 227 is separated from off-spec PVB 228 based on the inspection. On-spec PVB 227 is discharged from unit 225 and recovered. Off-spec PVB 228 is discharged from unit 225, optionally size reduced in unit 186, and recycled to unit 188 to produce additional PVB slurry 218 therefrom.

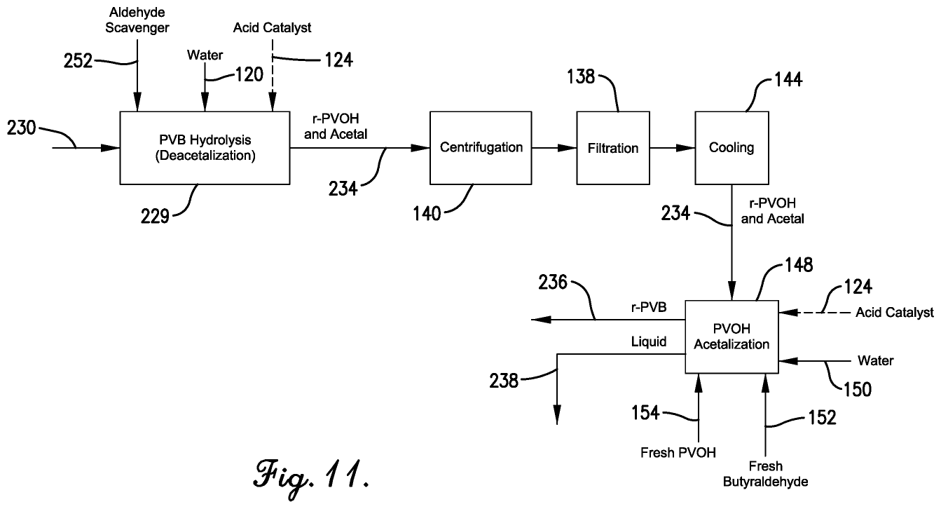

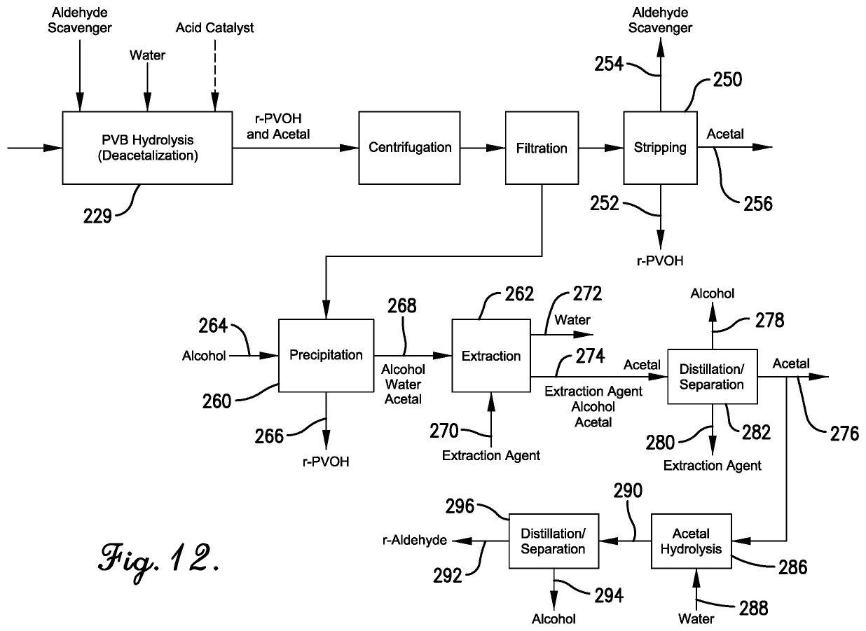

Referring now to FIGS. 11 and 12, PVB 230 (e.g., dried PVB 114, PVB solution 130, off-spec PVB 184, or PVB solution 202) is channeled to a hydrolysis unit 229 and hydrolyzed as described above to produce a solution comprising a number of hydrolyzed products in the form of recycled content products, which were directly derived from the PVB-containing composition. For example, the hydrolyzed products may comprise several recycled content products derived from the hydrolysis of the PVB resin, as described above. In the illustrated embodiment, the PVB may be hydrolyzed in the presence of water 120, an aldehyde scavenger 232, and, optionally, alcohol 122 and acid catalyst 124 to produce the solution comprising regenerated PVOH and regenerated acetal.

Without being bound by any particular theory, it is believed aldehyde scavenger 232 reacts with converted butyraldehyde, thereby limiting its conversion back to PVB. That is, aldehyde scavenger 232 reacts with the butyraldehyde to produce an acetal (i.e., a dioxane (1,3-dioxane, glycol acetal, or glycol butyral), which is generally soluble in the reaction product along with the regenerated PVOH. Thus, the hydrolysis reaction is driven towards the production of PVOH, and a mixture 234 comprising regenerated PVOH and the acetal is produced therefrom. Example aldehyde scavengers include, but are not limited to, C2 glycols (e.g., ethylene glycol), propane diol, methanol, ethanol, and acetoacetates.

Accordingly, mixture 234 comprises water, PVOH, the acetal, water-insoluble PVB, and/or a remainder of one or more additional components. The concentration of water may be greater than 25 percent, greater than 50 percent, greater than 75 percent, greater than 80 percent, greater than 85 percent, greater than 90 percent, greater than 95 percent, greater than 98 percent, greater than 99 percent, between 25 percent and 75 percent, between 30 percent and 70 percent, between 35 percent and 65 percent, or between 40 percent and 60 percent water, between 80 percent and 99 percent, between 85 percent and 99 percent, between 90 and 99 percent, or between 95 and 99 percent by weight of mixture 234.

The concentration of water-soluble PVOH may be less than 20 percent, less than 15 percent, less than 10 percent, less than 5 percent, less than 2 percent, less than 1 percent, or between 1 percent and 20 percent, between 1 percent and 15 percent, between 1 percent and 10 percent, or between 1 percent and 5 percent by weight of mixture 234.

The concentration of acetal may be between 1 percent and 25 percent, between 1 percent and 20 percent, between 1 percent and 15 percent, or between 5 percent and 15 percent by weight of mixture 234.

The concentration of water-insoluble PVB may be less than 25 percent, less than 20 percent, less than 15 percent, less than 10 percent, less than 5 percent, between 0 percent and 25 percent, between 1 percent and 25 percent, between 5 percent and 25 percent, or between 10 percent and 20 percent by weight of mixture 234.

The concentration of the remainder may be less than 20 percent, less than 15 percent, less than 10 percent, less than 5 percent, less than 2 percent, less than 1 percent, or between 1 percent and 20 percent, between 1 percent and 15 percent, between 1 percent and 10 percent, or between 1 percent and 5 percent by weight of mixture 234.

The remainder may include residual polyvinyl acetate (PVAC), residual alcohol, residual catalyst, butyraldehyde, and/or butyral. The concentration of these remainders may each be less than 5 percent, less than 2 percent, less than 1 percent, less than 0.5 percent, or less than 0.1 percent by weight of mixture 234.

Referring to FIG. 11, mixture 234 may also comprise one or more non-soluble components Thus, mixture 234 may be optionally filtered in unit 138, and/or centrifuged in unit 140. In some embodiments, the solution is cooled in unit 144 and then used to produce r-PVB 236 at unit 148.

At unit 148, the filtered and cooled mixture 234 is combined with water 150, fresh butyraldehyde 152, and fresh PVOH 154, optionally in the presence of acid catalyst 124, to produce r-PVB 236 and a liquid product 238. R-PVB 236 may be processed as described above. In one embodiment or in combination with any embodiment mentioned herein, liquid product 238 comprises the acetal and water, which may be separated and processed in a downstream unit.

Referring now to FIG. 12, once filtered and/or centrifuged, mixture 234 may be processed to recover the regenerated PVOH and the regenerated acetal therefrom. Specifically, in the illustrated embodiment, a portion of mixture 234 is channeled to a stripping unit 250, wherein at least one of regenerated PVOH 252 or aldehyde scavenger 254 is stripped from the solution. The regenerated PVOH may be recovered and stored for use in the production of regenerated PVB, for example, and aldehyde scavenger 254 may be recycled for further use in the hydrolysis step. In addition, regenerated acetal 256 may be recovered and stored for future use and/or processing.

In some embodiments, another portion of mixture 234 is processed to recover the regenerated PVOH and the regenerated acetal therefrom at a precipitation unit 260 and a liquid-liquid extraction unit 262. At precipitation unit 260, mixture 234 is combined with an alcohol 264 to precipitate regenerated PVOH 266 therefrom. A resulting liquid product 268, comprising alcohol, water, and acetal, is discharged from precipitation unit 260 and received at extraction unit 262. At extraction unit 262, liquid product 268 is combined with an extraction agent 270, such as toluene, to recover water 272, and a liquid product 274 comprising the extraction agent, alcohol, and acetal.

In the illustrated embodiment, acetal 276, alcohol 278, and extraction agent 280 are recovered from liquid product 274 at distillation/separation unit 282. In some embodiments, a portion of acetal 276 may be channeled to a hydrolysis unit 286 and reacted with water 288 to produce a liquid product 290 comprising regenerated aldehyde 292 and alcohol 294, which may be recovered at a distillation/separation unit 296. In some embodiments, regenerated aldehyde 292 may be channeled to a PVOH acetalization unit for use in the production of additional PVB.

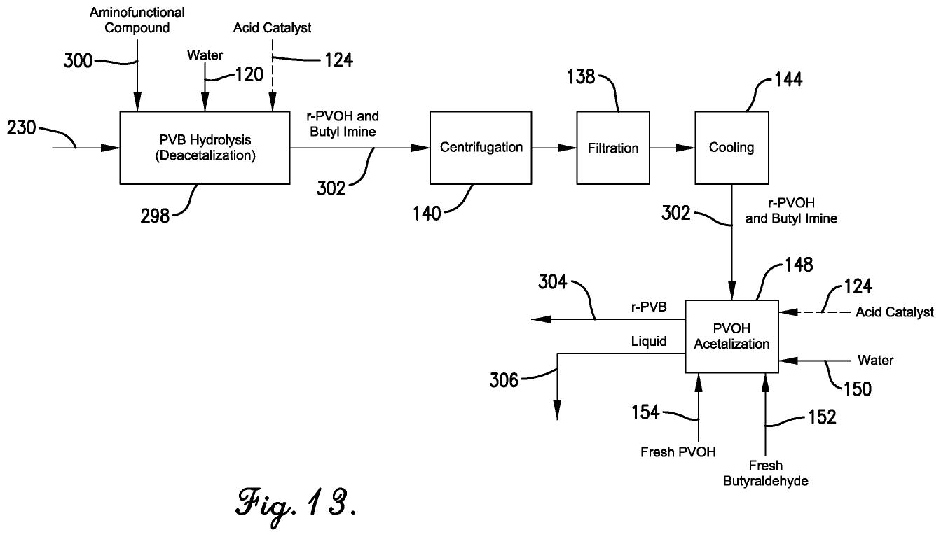

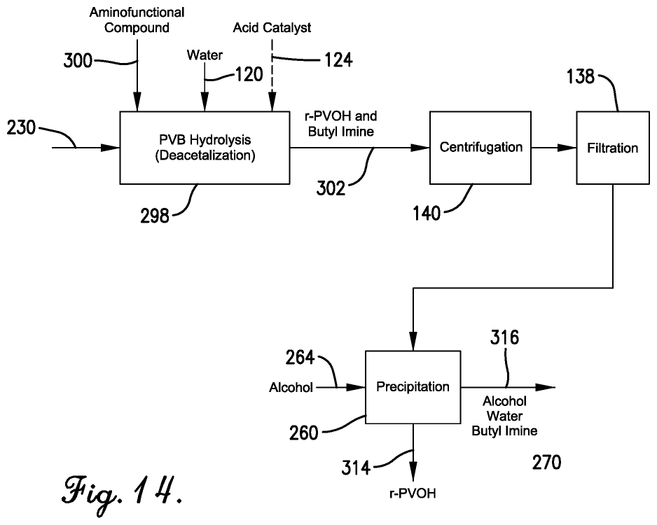

Referring now to FIGS. 13 and 14, PVB 230 (e.g., dried PVB 114, PVB solution 130, off-spec PVB 184, or PVB solution 202) is channeled to a hydrolysis unit 298 and hydrolyzed as described above to produce a solution comprising a number of hydrolyzed products in the form of recycled content products, which were directly derived from the PVB-containing composition. For example, the hydrolyzed products may comprise several recycled content products derived from the hydrolysis of the PVB resin, as described above. In the illustrated embodiment, PVB 230 may be hydrolyzed in the presence of water 120, at least one aminofunctional compound 300, and, optionally, alcohol 122 and acid catalyst 124 to produce the solution comprising regenerated PVOH and one or more butyl imine derivatives.

Without being bound by any particular theory, it is believed aminofunctional compound 300 reacts with the converted butyraldehyde, thereby limiting its conversion back to PVB. That is, aminofunctional compound 300 reacts with the butyraldehyde to produce one or more butyl imine derivatives. Thus, the hydrolysis reaction is driven towards the production of PVOH, and a mixture 302 comprising regenerated PVOH and one or more butyl imine derivatives is produced therefrom.

Example aminofunctional compounds include, but are not limited to, monofunctional amines, bifunctional amines, aromatic amines, ethanol amine, methyl amine, ethyl amine, ethyl diamine, propyl diamine, butyl amine, or ammonia. Thus, the butyl imine derivative produced is based on the aminofunctional compound used in unit 298. For example, the butyl imine derivative may be a monofunctional (i.e., unsaturated) derivative or a bifunctional (i.e., saturated) derivative. Example monofunctional derivatives include, but are not limited to, imines and enamines. Example bifunctional derivatives include, but are not limited to, oxazolidines and imidazolidines.

Accordingly, mixture 302 comprises water, PVOH, one or more butyl imine derivatives, water-insoluble PVB, and a remainder of one or more additional components. The concentration of water may be greater than 25 percent, greater than 50 percent, greater than 75 percent, greater than 80 percent, greater than 85 percent, greater than 90 percent, greater than 95 percent, greater than 98 percent, greater than 99 percent, between 25 percent and 75 percent, between 30 percent and 70 percent, between 35 percent and 65 percent, or between 40 percent and 60 percent water, between 80 percent and 99 percent, between 85 percent and 99 percent, between 90 and 99 percent, or between 95 and 99 percent by weight of mixture 302.

The concentration of water-soluble PVOH may be less than 20 percent, less than 15 percent, less than 10 percent, less than 5 percent, less than 2 percent, less than 1 percent, or between 1 percent and 20 percent, between 1 percent and 15 percent, between 1 percent and 10 percent, or between 1 percent and 5 percent by weight of mixture 302.

The concentration of the butyl imine derivative may be between 1 percent and 25 percent, between 1 percent and 20 percent, between 1 percent and 15 percent, or between 5 percent and 15 percent by weight of mixture 302.

The concentration of water-insoluble PVB may be less than 25 percent, less than 20 percent, less than 15 percent, less than 10 percent, less than 5 percent, between 0 percent and 25 percent, between 1 percent and 25 percent, between 5 percent and 25 percent, or between 10 percent and 20 percent by weight of mixture 302.

The concentration of the remainder may comprise less than 20 percent, less than 15 percent, less than 10 percent, less than 5 percent, less than 2 percent, less than 1 percent, or between 1 percent and 20 percent, between 1 percent and 15 percent, between 1 percent and 10 percent, or between 1 percent and 5 percent by weight of mixture 302.

The remainder may include residual polyvinyl acetate (PVAC), residual alcohol, residual catalyst, butyraldehyde, and/or butyral. The concentration of these remainders may each be less than 5 percent, less than 2 percent, less than 1 percent, less than 0.5 percent, or less than 0.1 percent by weight of mixture 302.

Referring to FIG. 13, mixture 302 may also comprise one or more non-soluble components. Thus, mixture 302 may be optionally filtered in unit 138, and/or centrifuged in unit 140. The solution is cooled in unit 144 and then used to produce r-PVB 304 at unit 148.

At unit 148, the filtered and cooled mixture 302 is combined with water 150, fresh butyraldehyde 152, and fresh PVOH 154, optionally in the presence of acid catalyst 124, to produce r-PVB 304 and a liquid product 306. R-PVB 304 may be processed as described above. In one embodiment or in combination with any embodiment mentioned herein, liquid product 306 comprises one or more butyl imine derivatives and water.

Referring now to FIG. 14, once filtered and/or centrifuged, mixture 302 may be processed to recover the regenerated PVOH and the one or more butyl imine derivatives therefrom. Specifically, in the illustrated embodiment, mixture 302 is processed at precipitation unit 260 to recover the regenerated PVOH therefrom. At precipitation unit 260, mixture 302 is combined with alcohol 264 to precipitate regenerated PVOH 314 therefrom. A resulting liquid product 316, comprising alcohol, water, and one or more butyl imine derivatives, is discharged from precipitation unit 260 and may be recovered and/or further processed to recover the butyl imine derivative therefrom.

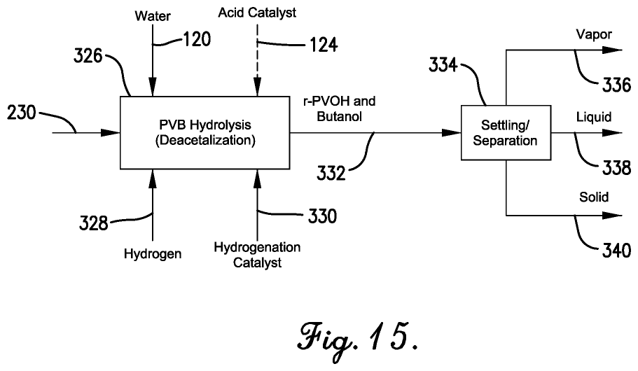

Referring now to FIG. 15, PVB 230 (e.g., dried PVB 114, PVB solution 130, off-spec PVB 184, or PVB solution 202) is channeled to a hydrolysis unit 326 and hydrolyzed as described above to produce a mixture comprising a number of hydrolyzed products in the form of recycled content products, which were directly derived from the PVB-containing composition. For example, the hydrolyzed products may comprise several recycled content products derived from the hydrolysis of the PVB resin, as described above. In the illustrated embodiment, PVB 230 may be hydrolyzed in the presence of water 120, hydrogen 328, a hydrogenation catalyst 330, and, optionally, alcohol 122 and acid catalyst 124 to produce the mixture comprising regenerated PVOH and regenerated butanol.

Without being bound by any particular theory, it is believed hydrogen 328 and a hydrogenation catalyst 330 reacts with the converted butyraldehyde, thereby limiting its conversion back to PVB. That is, hydrogen 328 and a hydrogenation catalyst 330 reacts with the butyraldehyde to produce butanol, for example. Thus, the hydrolysis reaction is driven towards the production of PVOH, and a mixture 332 comprising regenerated PVOH and regenerated butanol is produced therefrom.

Example hydrogenation catalysts include, but are not limited to, the Group 8 metals (e.g., iron (Fe), ruthenium (Ru), osmium (Os) and hassium (Hs)). Hydrogenation catalyst 330 may include one or more different hydrogenation catalysts. In addition, hydrogenation catalyst 330 may be heterogenous or homogeneous.

Accordingly, mixture 332 comprises water, PVOH, butanol, water-insoluble PVB, and a remainder of one or more additional components. The concentration of water may be greater than 25 percent, greater than 50 percent, greater than 75 percent, greater than 80 percent, greater than 85 percent, greater than 90 percent, greater than 95 percent, greater than 98 percent, greater than 99 percent, between 25 percent and 75 percent, between 30 percent and 70 percent, between 35 percent and 65 percent, or between 40 percent and 60 percent water, between 80 percent and 99 percent, between 85 percent and 99 percent, between 90 and 99 percent, or between 95 and 99 percent by weight of mixture 332.

The concentration of water-soluble PVOH may be less than 20 percent, less than 15 percent, less than 10 percent, less than 5 percent, less than 2 percent, less than 1 percent, or between 1 percent and 20 percent, between 1 percent and 15 percent, between 1 percent and 10 percent, or between 1 percent and 5 percent by weight of mixture 332.

The concentration of butanol may be between 1 percent and 25 percent, between 1 percent and 20 percent, between 1 percent and 15 percent, or between 5 percent and 15 percent by weight of mixture 332.

The concentration of water-insoluble PVB may be less than 25 percent, less than 20 percent, less than 15 percent, less than 10 percent, less than 5 percent, between 0 percent and 25 percent, between 1 percent and 25 percent, between 5 percent and 25 percent, or between 10 percent and 20 percent by weight of mixture 332.

The concentration of the remainder may be less than 20 percent, less than 15 percent, less than 10 percent, less than 5 percent, less than 2 percent, less than 1 percent, or between 1 percent and 20 percent, between 1 percent and 15 percent, between 1 percent and 10 percent, or between 1 percent and 5 percent by weight of mixture 332.

The remainder may include residual polyvinyl acetate (PVAC), residual alcohol, residual catalyst, butyraldehyde, and/or butyral. The concentration of these remainders may each be less than 5 percent, less than 2 percent, less than 1 percent, less than 0.5 percent, or less than 0.1 percent by weight of mixture 332.

In one embodiment or in combination with any embodiment mentioned herein, the hydrolysis at unit 326 is performed in one of a continuous stirred tank reactor, a bubble column reactor, a fixed/trickle bed reactor, or an autoclave reactor, for example. Accordingly, mixture 332 may comprise different compositions based on the type of reactor used to perform the hydrolysis step.

For example, in one embodiment, mixture 332 comprises water, PVOH, butanol, hydrogen, and hydrogenation catalyst. In such embodiments, mixture 332 is channeled to a settling/separation unit 334 to recover a vapor phase 336, a liquid phase 338, and a solids phase 340. The regenerated butanol and hydrogen may be recovered from vapor phase 336. The regenerated PVOH, regenerated butanol, and water may be recovered from liquid phase 338. The regenerated butanol may be recovered from liquid phase 338 by, for example, liquid-liquid extraction. The hydrogenation catalyst may be recovered from solids phase 340.

Alternatively, in fixed/trickle bed reactors for example, hydrogenation catalyst 330 remains within the reactor such that mixture 332 comprises water, PVOH, butanol, and hydrogen. In such embodiments, mixture 332 is channeled to settling/separation unit 334 to recover only vapor phase 336 and liquid phase 338. The regenerated butanol and hydrogen may be recovered from vapor phase 336. The regenerated PVOH, regenerated butanol, and water may be recovered from liquid phase 338.

In an additional numbered embodiment and subembodiments:
Embodiment A1. A method of recycling polyvinyl butyral (PVB), the method comprising: partially hydrolyzing a PVB feedstock to produce a reaction product comprising water-insoluble PVB and butyraldehyde, wherein the water-insoluble PVB comprises residual polyvinyl alcohol (PVOH); and reacting the residual PVOH with additional butyraldehyde to produce regenerated PVB.
A2. The method in accordance with A1, wherein the partially hydrolyzing of the PVB feedstock has a conversion rate of less than 90 percent, less than 80 percent, less than 70 percent, less than 60 percent, or less than 50 percent.
A3. The method in accordance with A1 or A2, wherein the partially hydrolyzing produces a slurry comprising the water-insoluble PVB in water.
A4. The method in accordance with any of A1-A3, wherein the partially hydrolyzing of the PVB feedstock produces a slurry that comprises between 25 percent and 75 percent, between 30 percent and 70 percent, between 35 percent and 65 percent, or between 40 percent and 60 percent water-insoluble PVB by weight.
A5. The method in accordance with any of A1-A4, wherein the partially hydrolyzing of the PVB feedstock produces a slurry that comprises greater than 25 percent, greater than 50 percent, greater than 75 percent, between 25 percent and 75 percent, between 30 percent and 70 percent, between 35 percent and 65 percent, or between 40 percent and 60 percent water by weight.
A6. The method in accordance with any of A1-A5, wherein the water-insoluble PVB has a higher residual PVOH content than the PVB feedstock.
A7. The method in accordance with any of A1-A6, wherein the regenerated PVB has a lower residual PVOH content than the water-insoluble PVB.
A8. The method in accordance with any of A1-A7, wherein the partially hydrolyzing of the PVB feedstock produces the water-insoluble PVB having a residual PVOH content of less than 90 percent, less than 80 percent, less than 70 percent, less than 60 percent, less than 50 percent, less than 40 percent, less than 30 percent, between 20 percent and 90 percent, between 30 percent and 90 percent, between 40 percent and 90 percent, between 50 percent and 90 percent, between 50 percent and 80 percent, or between 50 percent and 70 percent.
A9. The method in accordance with any of A1-A8 further comprising reacting the residual PVOH to produce the regenerated PVB having a residual PVOH content of between 1 percent and 90 percent, between 5 percent and 30 percent, between 7 percent and 30 percent, or between 16 percent and 20 percent.
A10. The method in accordance with any of A1-A9 further comprising reacting the residual PVOH to produce the regenerated PVB having a target residual PVOH content, wherein the PVB feedstock has a residual PVOH content that is greater than 1 percent, greater than 2 percent, greater than 3 percent, greater than 4 percent, greater than 5 percent, or greater than 10 percent from the target residual PVOH content.
A11. The method in accordance with any of A1-A10 further comprising reacting the residual PVOH with fresh butyraldehyde to produce the regenerated PVB.
A12. The method in accordance with any of A1-A11 further comprising performing the partial hydrolysis and reaction steps in separate units.
A13. The method in accordance with any of A1-A12 further comprising performing the partial hydrolysis and reaction steps in the same unit.
A14. The method in accordance with any of A1-A13, wherein the partially hydrolyzing is carried out in the presence of an acid catalyst.
A15. The method in accordance with A14, wherein the acid catalyst comprises at least one of organic sulfonic acid, nitric acid, sulfuric acid, or hydrochloric acid.
A16. The method in accordance with A14 or A15 further comprising producing the regenerated PVB in the presence of the same acid catalyst used in the partial hydrolysis step.
A17. The method in accordance with any of A1-A16, wherein the partially hydrolyzing is carried out at a temperature within a range between about 70° C. and about 250° C.
A18. The method in accordance with any of A14-A17, wherein the partially hydrolyzing is carried out at a temperature within a range between about 70° C. and about 150° C. when the hydrolysis step occurs in the presence of the acid catalyst.
A19. The method in accordance with any of A1-A13 or A17, wherein the partially hydrolyzing is carried out at a temperature within a range between about 150° C. and about 250° C. when the hydrolysis step does not occur in the presence of an acid catalyst.
A20. The method in accordance with any of A1-1A9, wherein the partially hydrolyzing is carried out in the presence of an alcohol.
A21. The method in accordance with any of A1-A20 further comprising dissolving the PVB feedstock in a solvent prior to the partially hydrolyzing of the PVB feedstock.
A22. The method in accordance with any of A20 and A21 further comprising dissolving the PVB feedstock in the solvent comprising the alcohol.
A23. The method in accordance with any of A1-A22 further comprising recovering butyraldehyde produced from the partially hydrolyzing of the PVB feedstock.
A24. The method in accordance with A23 further comprising producing the regenerated PVB from the recovered butyraldehyde.
A25. The method in accordance with any of A1-A24 further comprising: inspecting the regenerated PVB for at least one of oversizing, visual defects, compositional defects, gelling, or contamination; separating on-spec PVB from off-spec PVB based on the inspection; and partially hydrolyzing the off-spec PVB to increase the residual PVOH content of the off-spec PVB.
A26. The method in accordance with A25 further comprising size-reducing the off-spec PVB prior to the partially hydrolyzing of the off-spec PVB.
A27. The method in accordance with any of A25 or A26 further comprising size-reducing the off-spec PVB to an average particle size of less than about 400 microns, 300 microns, or 200 microns, or between about 200 and about 400 microns.
A28. The method in accordance with any of A1-A27 further comprising size-reducing the PVB feedstock prior to the partially hydrolyzing of the PVB feedstock.
A29. The method in accordance with any of A1-A28 further comprising size-reducing the PVB feedstock prior to the partially hydrolyzing of the PVB feedstock to an average particle size of less than about 400 microns, 350 microns, 300 microns, or 250 microns, or between about 200 and about 400 microns, between about 225 microns and about 375 microns, or between about 250 microns and about 350 microns.
A30. The method in accordance with any of A1-A29, wherein the PVB feedstock comprises two or more PVB resins having different compositions from one another.
A31. The method in accordance with any of A1-A30, wherein the PVB feedstock comprises two or more PVB resins having different residual PVOH contents from one another.
A32. The method in accordance with any of A1-A31 further comprising extracting plasticizer from the PVB feedstock prior to the partially hydrolyzing of the PVB feedstock.
A33. The method in accordance with A32 further comprising extracting plasticizer from the PVB feedstock comprising a PVB source material derived from at least one of post-industrial or post-consumer scrap material.
A34. The method in accordance with any of A1-A33 further comprising washing the PVB feedstock prior to the partially hydrolyzing of the PVB feedstock to remove non-soluble components.
A35. The method in accordance with any of A1-A34, wherein the PVB feedstock has a residual PVOH content of at least 8, at least 9, at least 9.5, at least 10, at least 10.5, at least 11, at least 11.5, at least 12, at least 12.5, at least 13, at least 13.5, at least 14, at least 14.5, at least 15, at least 15.5, at least 16, at least 16.5, at least 17, at least 17.5, at least 18, at least 18.5, at least 19, at least 19.5, at least 20, at least 25, at least 26, at least 30, at least 32, at least 35, at least 40, at least 50, at least 60, at least 70, at least 80, or at least 90 percent, and/or not more than 100, not more than 90, not more than 80, not more than 70, not more than 60, not more than 50, not more than 40, not more than 35, not more than 32, not more than 30, not more than 25, not more than 22, not more than 20, not more than 19, not more than 18, not more than 17, not more than 16, not more than 15, not more than 14, not more than 13, not more than 12, not more than 11, not more than 10, not more than 9, or not more than 8 percent.
A36. The method in accordance with any of A1-A35, wherein the PVB feedstock comprises at least 1, at least 5, at least 10, at least 15, at least 20, at least 25, at least 30, at least 35, at least 40, at least 45, at least 50, at least 55, at least 60, at least 65, at least 70, at least 75, at least 80, at least 85, or at least 90 phr, and/or not more than 100, not more than 90, not more than 85, not more than 80, not more than 75, not more than 70, not more than 65, not more than 60, not more than 55, not more than 50, not more than 45, not more than 40, not more than 35, not more than 30, not more than 25, not more than 20, not more than 15, or not more than 10 phr of plasticizer, based on the total weight of the PVB feedstock.
A37. The method in accordance with any of A1-A36, wherein the PVB feedstock comprises solid particles having an average particle size of at least 0.01, at least 0.05, at least 0.1, at least 0.2, at least 0.3, at least 0.4, at least 0.5, at least 1, or at least 2 inches.
A38. The method in accordance with any of A1-A37, wherein the PVB feedstock comprises less than 10, less than 5, less than 4, less than 3, less than 2, or less than 1, or less than 0.5 weight percent of solid contaminants, based on the total weight of the PVB feedstock.
A39. The method in accordance with any of A1-A38, wherein the PVB feedstock comprises at least 0.01, at least 0.1, at least 0.2, at least 0.3, at least 0.4, at least 0.5, at least 1, at least 1.5, at least 2, at least 2.5, at least 3, at least 3.5, at least 4, at least 4.5, or at least 5 and/or less than 50, less than 40, less than 30, less than 25, less than 20, less than 15, less than 10, less than 9, less than 8, less than 7, less than 6, less than 5, less than 4, less than 3, less than 2, or less than 1 weight percent of non-soluble components, based on the total weight of the PVB feedstock.
A40. The method in accordance with A39, wherein the non-soluble components comprise at least one polymer, wherein the polymer comprises a polyolefin, a polyester, a rubber, a polyamide, a polystyrene, or a combination thereof, and wherein the PVB feedstock comprises at least 0.01, at least 0.1, at least 0.2, at least 0.3, at least 0.4, at least 0.5, at least 1, at least 1.5, at least 2, at least 2.5, at least 3, at least 3.5, at least 4, at least 4.5, or at least 5 and/or less than 50, less than 40, less than 30, less than 25, less than 20, less than 15, less than 10, less than 9, less than 8, less than 7, less than 6, less than 5, less than 4, less than 3, less than 2, or less than 1 weight percent of the polymer.
A41. The method in accordance with A39, wherein the non-soluble components comprise rubber, and the PVB feedstock comprises at least 0.01, at least 0.1, at least 0.2, at least 0.3, at least 0.4, at least 0.5, at least 1, at least 1.5, at least 2, at least 2.5, at least 3, at least 3.5, at least 4, at least 4.5, or at least 5 and/or less than 50, less than 40, less than 30, less than 25, less than 20, less than 15, less than 10, less than 9, less than 8, less than 7, less than 6, less than 5, less than 4, less than 3, less than 2, or less than 1 weight percent of the rubber.
A42. The method in accordance with A39, wherein the non-soluble components comprise glass, metal, a salt, a silicate, calcium, a calcium derivative, a sodium derivative, or combinations thereof, and the PVB feedstock comprises at least 0.01, at least 0.1, at least 0.2, at least 0.3, at least 0.4, at least 0.5, at least 1, at least 1.5, at least 2, at least 2.5, at least 3, at least 3.5, at least 4, at least 4.5, or at least 5 and/or less than 50, less than 40, less than 30, less than 25, less than 20, less than 15, less than 10, less than 9, less than 8, less than 7, less than 6, less than 5, less than 4, less than 3, less than 2, or less than 1 weight percent of glass, metal, a salt, a silicate, calcium, a calcium derivative, a sodium derivative, or combinations thereof.
A43. A method of recycling polyvinyl butyral (PVB), the method comprising: producing a plurality of PVB particles from fresh polyvinyl alcohol (PVOH) and fresh butyraldehyde in the presence of water; partially hydrolyzing a quantity of the PVB particles to produce a reaction product comprising water-insoluble PVB and butyraldehyde, wherein the water-insoluble PVB comprises residual PVOH; and reacting the residual PVOH with additional butyraldehyde to produce regenerated PVB.
A44. The method in accordance with A43, wherein the partially hydrolyzing of the PVB particles has a conversion rate of less than 90 percent, less than 80 percent, less than 70 percent, less than 60 percent, or less than 50 percent.
A45. The method in accordance with any of A43 and A44, wherein the partially hydrolyzing produces a slurry comprising the water-insoluble PVB in water.
A46. The method in accordance with any of A43-A45, wherein the partially hydrolyzing of the PVB particles produces a slurry that comprises between 25 percent and 75 percent, between 30 percent and 70 percent, between 35 percent and 65 percent, or between 40 percent and 60 percent water-insoluble PVB by weight.
A47. The method in accordance with any of A43-A46, wherein the partially hydrolyzing of the PVB particles produces a slurry that comprises greater than 25 percent, greater than 50 percent, greater than 75 percent, between 25 percent and 75 percent, between 30 percent and 70 percent, between 35 percent and 65 percent, or between 40 percent and 60 percent water by weight.
A48. The method in accordance with any of A43-A47, wherein the water-insoluble PVB has a higher residual PVOH content than the PVB particles.
A49. The method in accordance with any of A43-A48, wherein the regenerated PVB has a lower residual PVOH content than the water-insoluble PVB.
A50. The method in accordance with any of A43-A49, wherein the partially hydrolyzing of the PVB particles produces the water-insoluble PVB having a residual PVOH content of less than 90 percent, less than 80 percent, less than 70 percent, less than 60 percent, less than 50 percent, less than 40 percent, less than 30 percent, between 20 percent and 90 percent, between 30 percent and 90 percent, between 40 percent and 90 percent, between 50 percent and 90 percent, between 50 percent and 80 percent, or between 50 percent and 70 percent.
A51. The method in accordance with any of A43-A50, wherein the partially hydrolyzing of the PVB particles produces the regenerated PVB having a residual PVOH content of between 1 percent and 90 percent, between 5 percent and 30 percent, between 7 percent and 30 percent, or between 16 percent and 20 percent.
A52. The method in accordance with any of A43-A51 further comprising reacting the residual PVOH to produce the regenerated PVB having a target residual PVOH content, wherein the PVB particles have a residual PVOH content that is greater than 1 percent, greater than 2 percent, greater than 3 percent, greater than 4 percent, greater than 5 percent, or greater than 10 percent from the target residual PVOH content.
A53. The method in accordance with any of A43-A52 further comprising reacting the residual PVOH with fresh butyraldehyde to produce the regenerated PVB.
A54. The method in accordance with any of A43-A53 further comprising performing the partial hydrolysis and reaction steps in separate units.
A55. The method in accordance with any of A43-A54 further comprising performing the partial hydrolysis and reaction steps in the same unit.
A56. The method in accordance with any of A43-A55, wherein the partially hydrolyzing is carried out in the presence of an acid catalyst.
A57. The method in accordance with A56, wherein the acid catalyst comprises at least one of organic sulfonic acid, nitric acid, sulfuric acid, or hydrochloric acid.
A58. The method in accordance with any of A56 and A57 further comprising producing the regenerated PVB in the presence of the same acid catalyst used in the partially hydrolyzing step.
A59. The method in accordance with any of A43-A58, wherein the partially hydrolyzing is carried out at a temperature within a range between about 70° C. and about 250° C.
A60. The method in accordance with any of A56-A59, wherein the partially hydrolyzing is carried out at a temperature within a range between about 70° C. and about 150° C. when the hydrolysis step occurs in the presence of the acid catalyst.
A61. The method in accordance with any of A43-A55 and A59, wherein the partially hydrolyzing is carried out at a temperature within a range between about 150° C. and about 250° C. when the hydrolysis step does not occur in the presence of an acid catalyst.
A62. The method in accordance with any of A43-A61, wherein the partially hydrolyzing is carried out in the presence of an alcohol.
A63. The method in accordance with any of A43-A62 further comprising dissolving the PVB particles in a solvent prior to the hydrolysis step.
A64. The method in accordance with any of A62 and A63 further comprising dissolving the PVB particles in the solvent comprising the alcohol.
A65. The method in accordance with any of A43-A64 further comprising recovering butyraldehyde produced from the partial hydrolyzing of the PVB particles.
A66. The method in accordance with A65 further comprising producing the regenerated PVB from the recovered butyraldehyde.
A67. The method in accordance with any of A43-A66 further comprising: inspecting the regenerated PVB for at least one of oversizing, visual defects, compositional defects, gelling, or contamination; separating on-spec PVB from off-spec PVB based on the inspection; and partially hydrolyzing the off-spec PVB to increase the residual PVOH content of the off-spec PVB.
A68. The method in accordance with A67 further comprising size-reducing the off-spec PVB prior to the partial hydrolyzing of the off-spec PVB.
A69. The method in accordance with any of A67 and A68 further comprising size-reducing the off-spec PVB to an average particle size of less than about 400 microns, 300 microns, or 200 microns, or between about 200 and about 400 microns.
Embodiment B1. A method of recycling polyvinyl butyral (PVB), the method comprising: hydrolyzing, in the presence of hydrogen and a hydrogenation catalyst, a PVB feedstock to produce a solution comprising regenerated polyvinyl alcohol (PVOH) and regenerated butanol.
B2. The method in accordance with B1, wherein the hydrogenation catalyst comprises at least one Group 8 metal.
B3. The method in accordance with any of B1 and B2, wherein the hydrogenation catalyst is heterogenous or homogeneous.
B4. The method in accordance with any of B1-B3, wherein the hydrolyzing is performed in at least one of a continuous stirred tank reactor, a bubble column reactor, a fixed bed reactor, a trickle bed reactor, or an autoclave reactor.
B5. The method in accordance with any of B1-B4 further comprising recovering at least one of the regenerated PVOH, the regenerated butanol, and the hydrogenation catalyst from the solution.
B6. The method in accordance with any of B1-B5, wherein the recovering comprises separating the solution into at least two of a vapor phase, a liquid phase, and a solids phase.
B7. The method in accordance with B6, wherein the recovering recovers the regenerated PVOH from the liquid phase.
B8. The method in accordance with any of B6 and B7, wherein the recovering recovers the regenerated butanol from at least one of the vapor phase or the liquid phase.
B9. The method in accordance with any of B6-B8, wherein the recovering recovers the hydrogenation catalyst from the solids phase.
B10. The method in accordance with any of B1-B9 further comprising reacting the regenerated PVOH with at least one of fresh butyraldehyde or fresh PVOH to produce regenerated PVB.
B11. The method in accordance with any of B1-B10 further comprising cooling the regenerated PVOH prior to the reacting step.
B12. The method in accordance with any of B1-B11, wherein the hydrolyzing is carried out at a pressure within a range between about 10 and about 2000 psia.
B13. The method in accordance with any of B1-B12, wherein the hydrolyzing is carried out in the presence of an acid catalyst.
B14. The method in accordance with B13, wherein the acid catalyst comprises at least one of organic sulfonic acid, nitric acid, sulfuric acid, or hydrochloric acid.
B15. The method in accordance with any of B13 and B14 further comprising producing the regenerated PVB in the presence of the same acid catalyst used in the hydrolyzing step.
B16. The method in accordance with any of B1-B15, wherein the hydrolyzing is carried out at a temperature within a range between about 70° C. and about 250° C.
B17. The method in accordance with any of B13-B16, wherein the hydrolyzing is carried out at a temperature within a range between about 70° C. and about 150° C. when the hydrolysis step occurs in the presence of the acid catalyst.
B18. The method in accordance with any of B1-B12 and B16, wherein the hydrolyzing is carried out at a temperature within a range between about 150° C. and about 250° C. when the hydrolysis step does not occur in the presence of an acid catalyst.
B19. The method in accordance with any of B1-B18, wherein the hydrolyzing of the PVB feedstock is carried out in the presence of an alcohol.
B20. The method in accordance with any of B1-B19 further comprising dissolving the PVB feedstock in a solvent prior to the hydrolyzing step.
B21. The method in accordance with any of B19 and B20 further comprising dissolving the PVB feedstock in the solvent comprising the alcohol.
B22. The method in accordance with any of B1-B21 further comprising: inspecting the regenerated PVB for at least one of oversizing, visual defects, compositional defects, gelling, or contamination; separating on-spec PVB from off-spec PVB based on the inspection; and hydrolyzing the off-spec PVB to produce additional regenerated PVOH and regenerated butanol.
B23. The method in accordance with B22 further comprising size-reducing the off-spec PVB prior to the hydrolyzing of the off-spec PVB.
B24. The method in accordance with any of B22 and B23 further comprising size-reducing the off-spec PVB to an average particle size of less than about 400 microns, 300 microns, or 200 microns, or between about 200 and about 400 microns.
B25. The method in accordance with any of B1-B24 further comprising size-reducing the PVB feedstock prior to the hydrolysis step.
B26. The method in accordance with any of B1-B25 further comprising size-reducing the PVB feedstock prior to the hydrolyzing step to an average particle size of less than about 400 microns, 350 microns, 300 microns, or 250 microns, or between about 200 and about 400 microns, between about 225 microns and about 375 microns, or between about 250 microns and about 350 microns.
B27. The method in accordance with any of B1-B26, wherein the PVB feedstock comprises two or more PVB resins having different compositions from one another.
B28. The method in accordance with any of B1-B27, wherein the PVB feedstock comprises two or more PVB resins having different residual PVOH contents from one another.
B29. The method in accordance with any of B1-B28 further comprising extracting plasticizer from the PVB feedstock prior to the hydrolyzing of the PVB feedstock.
B30. The method in accordance with B29 further comprising extracting plasticizer from the PVB feedstock comprising a PVB source material derived from at least one of post-industrial recycle or post-consumer recycle material.
B31. The method in accordance with any of B1-B30 further comprising washing the PVB feedstock prior to the hydrolyzing of the PVB feedstock to remove non-soluble components from the PVB feedstock.
B32. The method in accordance with any of B1-B31 further comprising centrifuging the solution to remove one or more non-soluble components from the solution.
B33. The method in accordance with any of B1-B32 further comprising filtering the solution to remove one or more non-soluble components from the solution.
B34. The method in accordance with any of B32 and B33 further comprising centrifuging the solution prior to the filtering step.
B35. The method in accordance with any of B1-B34, wherein the PVB feedstock has a residual PVOH content of at least 8, at least 9, at least 9.5, at least 10, at least 10.5, at least 11, at least 11.5, at least 12, at least 12.5, at least 13, at least 13.5, at least 14, at least 14.5, at least 15, at least 15.5, at least 16, at least 16.5, at least 17, at least 17.5, at least 18, at least 18.5, at least 19, at least 19.5, at least 20, at least 25, at least 26, at least 30, at least 32, at least 35, at least 40, at least 50, at least 60, at least 70, at least 80, or at least 90 percent, and/or not more than 100, not more than 90, not more than 80, not more than 70, not more than 60, not more than 50, not more than 40, not more than 35, not more than 32, not more than 30, not more than 25, not more than 22, not more than 20, not more than 19, not more than 18, not more than 17, not more than 16, not more than 15, not more than 14, not more than 13, not more than 12, not more than 11, not more than 10, not more than 9, or not more than 8 percent.
B36. The method in accordance with any of B1-B35, wherein the PVB feedstock comprises at least 1, at least 5, at least 10, at least 15, at least 20, at least 25, at least 30, at least 35, at least 40, at least 45, at least 50, at least 55, at least 60, at least 65, at least 70, at least 75, at least 80, at least 85, or at least 90 phr, and/or not more than 100, not more than 90, not more than 85, not more than 80, not more than 75, not more than 70, not more than 65, not more than 60, not more than 55, not more than 50, not more than 45, not more than 40, not more than 35, not more than 30, not more than 25, not more than 20, not more than 15, or not more than 10 phr of plasticizer, based on the total weight of the PVB feedstock.
B37. The method in accordance with any of B1-B36, wherein the PVB feedstock comprises solid particles having an average particle size of at least 0.01, at least 0.05, at least 0.1, at least 0.2, at least 0.3, at least 0.4, at least 0.5, at least 1, or at least 2 inches.
B38. The method in accordance with any of B-B37, wherein the PVB feedstock comprises less than 10, less than 5, less than 4, less than 3, less than 2, or less than 1, or less than 0.5 weight percent of solid contaminants, based on the total weight of the PVB feedstock.
B39. The method in accordance with any of B1-B38, wherein the PVB feedstock comprises at least 0.01, at least 0.1, at least 0.2, at least 0.3, at least 0.4, at least 0.5, at least 1, at least 1.5, at least 2, at least 2.5, at least 3, at least 3.5, at least 4, at least 4.5, or at least 5 and/or less than 50, less than 40, less than 30, less than 25, less than 20, less than 15, less than 10, less than 9, less than 8, less than 7, less than 6, less than 5, less than 4, less than 3, less than 2, or less than 1 weight percent of non-soluble components, based on the total weight of the PVB feedstock.
B40. The method in accordance with B39, wherein the non-soluble components comprise at least one polymer, wherein the polymer comprises a polyolefin, a polyester, a rubber, a polyamide, a polystyrene, or a combination thereof, and wherein the PVB feedstock comprises at least 0.01, at least 0.1, at least 0.2, at least 0.3, at least 0.4, at least 0.5, at least 1, at least 1.5, at least 2, at least 2.5, at least 3, at least 3.5, at least 4, at least 4.5, or at least 5 and/or less than 50, less than 40, less than 30, less than 25, less than 20, less than 15, less than 10, less than 9, less than 8, less than 7, less than 6, less than 5, less than 4, less than 3, less than 2, or less than 1 weight percent of the polymer.
B41. The method in accordance with B39, wherein the non-soluble components comprise rubber, and the PVB feedstock comprises at least 0.01, at least 0.1, at least 0.2, at least 0.3, at least 0.4, at least 0.5, at least 1, at least 1.5, at least 2, at least 2.5, at least 3, at least 3.5, at least 4, at least 4.5, or at least 5 and/or less than 50, less than 40, less than 30, less than 25, less than 20, less than 15, less than 10, less than 9, less than 8, less than 7, less than 6, less than 5, less than 4, less than 3, less than 2, or less than 1 weight percent of the rubber.
B42. The method in accordance with B39, wherein the non-soluble components comprise glass, metal, a salt, a silicate, calcium, a calcium derivative, a sodium derivative, or combinations thereof, and the PVB feedstock comprises at least 0.01, at least 0.1, at least 0.2, at least 0.3, at least 0.4, at least 0.5, at least 1, at least 1.5, at least 2, at least 2.5, at least 3, at least 3.5, at least 4, at least 4.5, or at least 5 and/or less than 50, less than 40, less than 30, less than 25, less than 20, less than 15, less than 10, less than 9, less than 8, less than 7, less than 6, less than 5, less than 4, less than 3, less than 2, or less than 1 weight percent of glass, metal, a salt, a silicate, calcium, a calcium derivative, a sodium derivative, or combinations thereof.
B43. A method of recycling polyvinyl butyral (PVB), the method comprising: producing a plurality of PVB particles from fresh polyvinyl alcohol (PVOH) and fresh butyraldehyde in the presence of water; hydrolyzing, in the presence of at least one aminofunctional compound, a quantity of the PVB particles to produce a solution comprising regenerated PVOH and regenerated butanol; and producing, in the presence of water, additional PVB particles from the regenerated PVOH.
B44. The method in accordance with B43, wherein the hydrogenation catalyst comprises at least one Group 8 metal.
B45. The method in accordance with any of B43 and B44, wherein the Hydrogenation catalyst is heterogenous or homogeneous.
B46. The method in accordance with any of B43-B45, wherein the hydrolyzing is performed in at least one of a continuous stirred tank reactor, a bubble column reactor, a fixed bed reactor, a trickle bed reactor, or an autoclave reactor.
B47. The method in accordance with any of B43-B46 further comprising recovering at least one of the regenerated PVOH, the regenerated butanol, and the hydrogenation catalyst from the solution.
B48. The method in accordance with any of B43-B47, wherein the recovering comprises separating the solution into at least two of a vapor phase, a liquid phase, and a solids phase.
B49. The method in accordance with B48, wherein the recovering recovers the regenerated PVOH from the liquid phase.
B50. The method in accordance with any of B48 and B49, wherein the recovering recovers the regenerated butanol from at least one of the vapor phase or the liquid phase.
B51. The method in accordance with any of B48-B50, wherein the recovering recovers the hydrogenation catalyst from the solids phase.
B52. The method in accordance with any of B43-B51 further comprising reacting the regenerated PVOH with at least one of fresh butyraldehyde or fresh PVOH to produce regenerated PVB.
B53. The method in accordance with any of B43-B52 further comprising cooling the regenerated PVOH prior to the reacting step.
B54. The method in accordance with any of B43-B53, wherein the hydrolyzing is carried out at a pressure within a range between about 10 and about 2000 psia.
B55. The method in accordance with any of B43-B54, wherein the hydrolyzing is carried out in the presence of an acid catalyst.
B56. The method in accordance with B55, wherein the acid catalyst comprises at least one of organic sulfonic acid, nitric acid, sulfuric acid, or hydrochloric acid.
B57. The method in accordance with any of B55 and B56 further comprising producing the regenerated PVB in the presence of the same acid catalyst used in the hydrolyzing step.
B58. The method in accordance with any of B43-B57, wherein the hydrolyzing is carried out at a temperature within a range between about 100° C. and about 250° C.
B59. The method in accordance with any of B43-B58, wherein the hydrolyzing is carried out at a temperature within a range between about 100° C. and about 150° C. when the hydrolysis step occurs in the presence of the acid catalyst.
B60. The method in accordance with any of B43-B54 and B58, wherein the hydrolyzing is carried out at a temperature within a range between about 150° C. and about 250° C. when the hydrolysis step does not occur in the presence of an acid catalyst.
B61. The method in accordance with any of B43-B60, wherein the hydrolyzing of the PVB particles is carried out in the presence of an alcohol.
B62. The method in accordance with any of B43-B61 further comprising dissolving the PVB particles in a solvent prior to the hydrolysis step.
B63. The method in accordance with any of B61 and B62 further comprising dissolving the PVB particles in the solvent comprising the alcohol.
B64. The method in accordance with any of B43-B63 further comprising: inspecting the regenerated PVB for at least one of oversizing, visual defects, compositional defects, gelling, or contamination; separating on-spec PVB from off-spec PVB based on the inspection; and hydrolyzing the off-spec PVB to produce additional regenerated PVOH and regenerated butanol.
B65. The method in accordance with B64 further comprising size-reducing the off-spec PVB prior to the hydrolyzing of the off-spec PVB.
B66. The method in accordance with any of B64 and B65 further comprising size-reducing the off-spec PVB to an average particle size of less than about 400 microns, 300 microns, or 200 microns, or between about 200 and about 400 microns.
Embodiment C1. A method of recycling polyvinyl butyral (PVB), the method comprising: hydrolyzing, in the presence of an aldehyde scavenger, a PVB feedstock to produce a solution comprising regenerated polyvinyl alcohol (PVOH) and regenerated acetal.
C2. The method in accordance with C1, wherein the aldehyde scavenger comprises at least one of C2 glycols, propane diol, methanol, ethanol, or acetocetates.
C3. The method in accordance with any of C1 and C2 further comprising reacting the regenerated PVOH with at least one of fresh butyraldehyde or fresh PVOH to produce regenerated PVB.
C4. The method in accordance with any of C1-C3 further comprising cooling the regenerated PVOH prior to the reacting step.
C5. The method in accordance with any of C1-C4 further comprising: reacting the regenerated PVOH with at least one of fresh butyraldehyde or fresh PVOH to produce the regenerated PVB and a first liquid product; and recovering the first liquid product comprising the regenerated acetal.
C6. The method in accordance with any of C1-C5 further comprising stripping at least one of the regenerated PVOH or the aldehyde scavenger from the solution.
C7. The method in accordance with any of C1-C6, wherein the hydrolyzing is carried out in the presence of the regenerated solvent.
C8. The method in accordance with any of C1-C7 further comprising precipitating, in the presence of alcohol, the regenerated PVOH from the solution.
C9. The method in accordance with C8, wherein recovering the regenerated acetal comprises performing at least one of liquid-liquid extraction or distillation on the second liquid product.
C10. The method in accordance with any of C1-C9 further comprising hydrolyzing the recovered regenerated acetal to produce regenerated aldehyde.
C11. The method in accordance with any of C1-C10, wherein the hydrolyzing is carried out in the presence of an acid catalyst.
C12. The method in accordance with C11, wherein the acid catalyst comprises at least one of organic sulfonic acid, nitric acid, sulfuric acid, or hydrochloric acid.
C13. The method in accordance with any of C11 and C12 further comprising producing the regenerated PVB in the presence of the same acid catalyst used in the hydrolyzing step.
C14. The method in accordance with any of C1-C13, wherein the hydrolyzing is carried out at a temperature within a range between about 70° C. and about 250° C.
C15. The method in accordance with any of C11-C14, wherein the hydrolyzing is carried out at a temperature within a range between about 70° C. and about 150° C. when the hydrolysis step occurs in the presence of the acid catalyst.
C16. The method in accordance with any of C1-C10 and C14, wherein the hydrolyzing is carried out at a temperature within a range between about 150° C. and about 250° C. when the hydrolysis step does not occur in the presence of an acid catalyst.
C17. The method in accordance with any of C1-C16, wherein the hydrolyzing of the PVB feedstock is carried out in the presence of an alcohol.
C18. The method in accordance with any of C1-C17 further comprising dissolving the PVB feedstock in a solvent prior to the hydrolyzing of the PVB feedstock.
C19. The method in accordance with any of C17 and C18 further comprising dissolving the PVB feedstock in the solvent comprising the alcohol.
C20. The method in accordance with any of C1-C19 further comprising: inspecting the regenerated PVB for at least one of oversizing, visual defects, compositional defects, gelling, or contamination; separating on-spec PVB from off-spec PVB based on the inspection; and hydrolyzing the off-spec PVB to produce additional regenerated PVOH.
C21. The method in accordance with C20 further comprising size-reducing the off-spec PVB prior to the hydrolyzing of the off-spec PVB.
C22. The method in accordance with any of C20 and C21 further comprising size-reducing the off-spec PVB to an average particle size of less than about 400 microns, 300 microns, or 200 microns, or between about 200 and about 400 microns.
C23. The method in accordance with any of C1-C22 further comprising size-reducing the PVB feedstock prior to the hydrolyzing step.
C24. The method in accordance with any of C1-C23 further comprising size-reducing the PVB feedstock prior to the hydrolyzing step to an average particle size of less than about 400 microns, 350 microns, 300 microns, or 250 microns, or between about 200 and about 400 microns, between about 225 microns and about 375 microns, or between about 250 microns and about 350 microns.
C25. The method in accordance with any of C1-C24, wherein the PVB feedstock comprises two or more PVB resins having different compositions from one another.
C26. The method in accordance with any of C1-C25, wherein the PVB feedstock comprises two or more PVB resins having different residual PVOH contents from one another.
C27. The method in accordance with any of C1-C26 further comprising extracting plasticizer from the PVB feedstock prior to the hydrolyzing of the PVB feedstock.
C28. The method in accordance with C27 further comprising extracting plasticizer from the PVB feedstock comprising a PVB source material derived from at least one of post-industrial recycle or post-consumer recycle material.
C29. The method in accordance with any of C1-C28 further comprising washing the PVB feedstock prior to the hydrolyzing of the PVB feedstock to remove non-soluble components from the PVB feedstock.
C30. The method in accordance with any of C1-C29 further comprising centrifuging the solution to remove one or more non-soluble components from the solution.
C31. The method in accordance with any of C1-C30 further comprising filtering the solution to remove one or more non-soluble components from the solution.
C32. The method in accordance with any of C30 and C31 further comprising centrifuging the solution prior to the filtering of the solution.
C33. The method in accordance with any of C1-C32 further comprising recovering and storing the regenerated PVOH from the solution.
C34. The method in accordance with any of C1-C33, wherein the PVB feedstock has a residual PVOH content of at least 8, at least 9, at least 9.5, at least 10, at least 10.5, at least 11, at least 11.5, at least 12, at least 12.5, at least 13, at least 13.5, at least 14, at least 14.5, at least 15, at least 15.5, at least 16, at least 16.5, at least 17, at least 17.5, at least 18, at least 18.5, at least 19, at least 19.5, at least 20, at least 25, at least 26, at least 30, at least 32, at least 35, at least 40, at least 50, at least 60, at least 70, at least 80, or at least 90 percent, and/or not more than 100, not more than 90, not more than 80, not more than 70, not more than 60, not more than 50, not more than 40, not more than 35, not more than 32, not more than 30, not more than 25, not more than 22, not more than 20, not more than 19, not more than 18, not more than 17, not more than 16, not more than 15, not more than 14, not more than 13, not more than 12, not more than 11, not more than 10, not more than 9, or not more than 8 percent.
C35. The method in accordance with any of C1-C34, wherein the PVB feedstock comprises at least 1, at least 5, at least 10, at least 15, at least 20, at least 25, at least 30, at least 35, at least 40, at least 45, at least 50, at least 55, at least 60, at least 65, at least 70, at least 75, at least 80, at least 85, or at least 90 phr, and/or not more than 100, not more than 90, not more than 85, not more than 80, not more than 75, not more than 70, not more than 65, not more than 60, not more than 55, not more than 50, not more than 45, not more than 40, not more than 35, not more than 30, not more than 25, not more than 20, not more than 15, or not more than 10 phr of plasticizer, based on the total weight of the PVB feedstock.
C36. The method in accordance with any of C1-C35, wherein the PVB feedstock comprises solid particles having an average particle size of at least 0.01, at least 0.05, at least 0.1, at least 0.2, at least 0.3, at least 0.4, at least 0.5, at least 1, or at least 2 inches.
C37. The method in accordance with any of C1-C36, wherein the PVB feedstock comprises less than 10, less than 5, less than 4, less than 3, less than 2, or less than 1, or less than 0.5 weight percent of solid contaminants, based on the total weight of the PVB feedstock.
C38. The method in accordance with any of C1-C37, wherein the PVB feedstock comprises at least 0.01, at least 0.1, at least 0.2, at least 0.3, at least 0.4, at least 0.5, at least 1, at least 1.5, at least 2, at least 2.5, at least 3, at least 3.5, at least 4, at least 4.5, or at least 5 and/or less than 50, less than 40, less than 30, less than 25, less than 20, less than 15, less than 10, less than 9, less than 8, less than 7, less than 6, less than 5, less than 4, less than 3, less than 2, or less than 1 weight percent of non-soluble components, based on the total weight of the PVB feedstock.
C39. The method in accordance with C38, wherein the non-soluble components comprise at least one polymer, wherein the polymer comprises a polyolefin, a polyester, a rubber, a polyamide, a polystyrene, or a combination thereof, and wherein the PVB feedstock comprises at least 0.01, at least 0.1, at least 0.2, at least 0.3, at least 0.4, at least 0.5, at least 1, at least 1.5, at least 2, at least 2.5, at least 3, at least 3.5, at least 4, at least 4.5, or at least 5 and/or less than 50, less than 40, less than 30, less than 25, less than 20, less than 15, less than 10, less than 9, less than 8, less than 7, less than 6, less than 5, less than 4, less than 3, less than 2, or less than 1 weight percent of the polymer.
C40. The method in accordance with C38, wherein the non-soluble components comprise rubber, and the PVB feedstock comprises at least 0.01, at least 0.1, at least 0.2, at least 0.3, at least 0.4, at least 0.5, at least 1, at least 1.5, at least 2, at least 2.5, at least 3, at least 3.5, at least 4, at least 4.5, or at least 5 and/or less than 50, less than 40, less than 30, less than 25, less than 20, less than 15, less than 10, less than 9, less than 8, less than 7, less than 6, less than 5, less than 4, less than 3, less than 2, or less than 1 weight percent of the rubber.
C41. The method in accordance with C38, wherein the non-soluble components comprise glass, metal, a salt, a silicate, calcium, a calcium derivative, a sodium derivative, or combinations thereof, and the PVB feedstock comprises at least 0.01, at least 0.1, at least 0.2, at least 0.3, at least 0.4, at least 0.5, at least 1, at least 1.5, at least 2, at least 2.5, at least 3, at least 3.5, at least 4, at least 4.5, or at least 5 and/or less than 50, less than 40, less than 30, less than 25, less than 20, less than 15, less than 10, less than 9, less than 8, less than 7, less than 6, less than 5, less than 4, less than 3, less than 2, or less than 1 weight percent of glass, metal, a salt, a silicate, calcium, a calcium derivative, a sodium derivative, or combinations thereof.
C42. A method of recycling polyvinyl butyral (PVB), the method comprising: producing a plurality of PVB particles from fresh polyvinyl alcohol and fresh butyraldehyde in the presence of water; hydrolyzing, in the presence of an aldehyde scavenger, a quantity of the PVB particles to produce a solution comprising regenerated PVOH; and producing, in the presence of water, additional PVB particles from the regenerated PVOH.
C43. The method in accordance with C42, wherein the aldehyde scavenger comprises at least one of C2 glycols, propane diol, methanol, ethanol, or acetocetates.
C44. The method in accordance with any of C42 and C43 further comprising reacting the regenerated PVOH with at least one of fresh butyraldehyde or fresh PVOH to produce regenerated PVB.
C45. The method in accordance with any of C42-C44 further comprising cooling the regenerated PVOH prior to the reacting step.
C46. The method in accordance with any of C42-C45 further comprising: reacting the regenerated PVOH with at least one of fresh butyraldehyde or fresh PVOH to produce the regenerated PVB and a first liquid product; and recovering the first liquid product comprising the regenerated acetal.
C47. The method in accordance with any of C42-C46 further comprising stripping at least one of the regenerated PVOH or the aldehyde scavenger from the solution.
C48. The method in accordance with any of C42-C47, wherein the hydrolyzing is carried out in the presence of the regenerated solvent.
C49. The method in accordance with any of C42-C48 further comprising precipitating, in the presence of alcohol, the regenerated PVOH from the solution.
C50. The method in accordance with C49, wherein recovering the regenerated acetal comprises performing at least one of liquid-liquid extraction or distillation on the second liquid product.
C51. The method in accordance with any of C42-C50, further comprising hydrolyzing the recovered regenerated acetal to produce regenerated aldehyde.
C52. The method in accordance with any of C42-C51, wherein the hydrolyzing is carried out in the presence of an acid catalyst.
C53. The method in accordance with C52, wherein the acid catalyst comprises at least one of organic sulfonic acid, nitric acid, sulfuric acid, or hydrochloric acid.
C54. The method in accordance with any of C52 and C53 further comprising producing the regenerated PVB in the presence of the same acid catalyst used in the hydrolyzing of the PVB particles.
C55. The method in accordance with any of C42-C54, wherein the hydrolyzing is carried out at a temperature within a range between about 70° C. and about 250° C.
C56. The method in accordance with any of C52-C55, wherein the hydrolyzing is carried out at a temperature within a range between about 70° C. and about 150° C. when the hydrolysis step occurs in the presence of the acid catalyst.
C57. The method in accordance with any of C42-C51 and C55, wherein the hydrolyzing is carried out at a temperature within a range between about 150° C. and about 250° C. when the hydrolysis step does not occur in the presence of an acid catalyst.
C58. The method in accordance with any of C42-C57, wherein the hydrolyzing of the PVB particles is carried out in the presence of an alcohol.
C59. The method in accordance with any of C42-C58 further comprising dissolving the PVB particles in a solvent prior to the hydrolysis step.
C60. The method in accordance with any of C58 and C59 further comprising dissolving the PVB particles in the solvent comprising the alcohol.
C61. The method in accordance with any of C42-C60 further comprising: inspecting the regenerated PVB for at least one of oversizing, visual defects, compositional defects, gelling, or contamination; separating on-spec PVB from off-spec PVB based on the inspection; and hydrolyzing the off-spec PVB to produce additional regenerated PVOH.
C62. The method in accordance with C61 further comprising size-reducing the off-spec PVB prior to the hydrolyzing of the off-spec PVB.
C63. The method in accordance with any of C61 and C62 further comprising size-reducing the off-spec PVB to an average particle size of less than about 400 microns, 300 microns, or 200 microns, or between about 200 and about 400 microns.
C64. The method in accordance with any of C42-C63 further comprising recovering and storing the regenerated PVOH from the solution.
Embodiment D1. A method of recycling polyvinyl butyral (PVB), the method comprising: hydrolyzing, in the presence of at least one aminofunctional compound, a PVB feedstock to produce a solution comprising regenerated polyvinyl alcohol (PVOH) and one or more butyl imine derivatives.
D2. The method in accordance with D1, wherein the at least one aminofunctional compound comprises at least one of monofunctional amines, bifunctional amines, aromatic amines, ethanol amine, methyl amine, ethyl amine, ethyl diamine, propyl diamine, butyl amine, or ammonia.
D3. The method in accordance with any of D1 and D2 further comprising reacting the regenerated PVOH with at least one of fresh butyraldehyde or fresh PVOH to produce regenerated PVB.
D4. The method in accordance with any of D1-D3 further comprising cooling the regenerated PVOH prior to the reacting step.
D5. The method in accordance with any of D1-D4 further comprising: reacting the regenerated PVOH with at least one of fresh butyraldehyde or fresh PVOH to produce the regenerated PVB and a first liquid product; and recovering the first liquid product comprising the one or more butyl imine derivatives.
D6. The method in accordance with any of D1-D5 further comprising precipitating, in the presence of alcohol, the regenerated PVOH from the solution.
D7. The method in accordance with any of D1-D6 further comprising: recovering a second liquid product separated from the precipitated PVOH; and recovering the one or more butyl imine derivatives from the second liquid product.
D8. The method in accordance with D7, wherein recovering the one or more butyl imine derivatives comprises performing at least one of liquid-liquid extraction or distillation on the second liquid product.
D9. The method in accordance with any of D1-D8, wherein the hydrolyzing is carried out in the presence of an acid catalyst.
D10. The method in accordance with D9, wherein the acid catalyst comprises at least one of organic sulfonic acid, nitric acid, sulfuric acid, or hydrochloric acid.
D11. The method in accordance with any of D9 and D10 further comprising producing the regenerated PVB in the presence of the same acid catalyst used in the hydrolyzing of the PVB feedstock.
D12. The method in accordance with any of D1-D11, wherein the hydrolyzing is carried out at a temperature within a range between about 70° C. and about 250° C.
D13. The method in accordance with any of D9-D12, wherein the hydrolyzing is carried out at a temperature within a range between about 70° C. and about 150° C. when the hydrolysis step occurs in the presence of the acid catalyst.
D14. The method in accordance with any of D1-D8 and D12, wherein the hydrolyzing is carried out at a temperature within a range between about 150° C. and about 250° C. when the hydrolysis step does not occur in the presence of an acid catalyst.
D15. The method in accordance with any of D1-D14, wherein the hydrolyzing of the PVB feedstock is carried out in the presence of an alcohol.
D16. The method in accordance with any of D1-D15 further comprising dissolving the PVB feedstock in a solvent prior to the hydrolysis step.
D17. The method in accordance with any of D14 and D15 further comprising dissolving the PVB feedstock in the solvent comprising the alcohol.
D18. The method in accordance with any of D1-D17 further comprising: inspecting the regenerated PVB for at least one of oversizing, visual defects, compositional defects, gelling, or contamination; separating on-spec PVB from off-spec PVB based on the inspection; and hydrolyzing the off-spec PVB to produce additional regenerated PVOH.
D19. The method in accordance with D18 further comprising size-reducing the off-spec PVB prior to the hydrolyzing of the off-spec PVB.
D20. The method in accordance with any of D18 and D19 further comprising size-reducing the off-spec PVB to an average particle size of less than about 400 microns, 300 microns, or 200 microns, or between about 200 and about 400 microns.
D21. The method in accordance with any of D1-D20 further comprising size-reducing the PVB feedstock prior to the hydrolyzing step.
D22. The method in accordance with any of D1-D21 further comprising size-reducing the PVB feedstock prior to the hydrolyzing step to an average particle size of less than about 400 microns, 350 microns, 300 microns, or 250 microns, or between about 200 and about 400 microns, between about 225 microns and about 375 microns, or between about 250 microns and about 350 microns.
D23. The method in accordance with any of D1-D22, wherein the PVB feedstock comprises two or more PVB resins having different compositions from one another.
D24. The method in accordance with any of D1-D23, wherein the PVB feedstock comprises two or more PVB resins having different residual PVOH contents from one another.
D25. The method in accordance with any of D1-D24 further comprising extracting plasticizer from the PVB feedstock prior to the hydrolyzing of the PVB feedstock.
D26. The method in accordance with D25 further comprising extracting plasticizer from the PVB feedstock comprising a PVB source material derived from at least one of post-industrial recycle or post-consumer recycle material.
D27. The method in accordance with any of D1-D26 further comprising washing the PVB feedstock prior to the hydrolyzing of the PVB feedstock to remove non-soluble components from the PVB feedstock.
D28. The method in accordance with any of D1-D27 further comprising centrifuging the solution to remove one or more non-soluble components from the solution.
D29. The method in accordance with any of D1-D28 further comprising filtering the solution to remove one or more non-soluble components from the solution.
D30. The method in accordance with any of D28 and D29 further comprising centrifuging the solution prior to the filtering step.
D31. The method in accordance with any of D1-D30 further comprising recovering and storing the regenerated PVOH from the solution.
D32. The method in accordance with any of D1-D31, wherein the PVB feedstock has a residual PVOH content of at least 8, at least 9, at least 9.5, at least 10, at least 10.5, at least 11, at least 11.5, at least 12, at least 12.5, at least 13, at least 13.5, at least 14, at least 14.5, at least 15, at least 15.5, at least 16, at least 16.5, at least 17, at least 17.5, at least 18, at least 18.5, at least 19, at least 19.5, at least 20, at least 25, at least 26, at least 30, at least 32, at least 35, at least 40, at least 50, at least 60, at least 70, at least 80, or at least 90 percent, and/or not more than 100, not more than 90, not more than 80, not more than 70, not more than 60, not more than 50, not more than 40, not more than 35, not more than 32, not more than 30, not more than 25, not more than 22, not more than 20, not more than 19, not more than 18, not more than 17, not more than 16, not more than 15, not more than 14, not more than 13, not more than 12, not more than 11, not more than 10, not more than 9, or not more than 8 percent.
D33. The method in accordance with any of D1-D32, wherein the PVB feedstock comprises at least 1, at least 5, at least 10, at least 15, at least 20, at least 25, at least 30, at least 35, at least 40, at least 45, at least 50, at least 55, at least 60, at least 65, at least 70, at least 75, at least 80, at least 85, or at least 90 phr, and/or not more than 100, not more than 90, not more than 85, not more than 80, not more than 75, not more than 70, not more than 65, not more than 60, not more than 55, not more than 50, not more than 45, not more than 40, not more than 35, not more than 30, not more than 25, not more than 20, not more than 15, or not more than 10 phr of plasticizer, based on the total weight of the PVB feedstock.
D34. The method in accordance with any of D1-D33, wherein the PVB feedstock comprises solid particles having an average particle size of at least 0.01, at least 0.05, at least 0.1, at least 0.2, at least 0.3, at least 0.4, at least 0.5, at least 1, or at least 2 inches.
D35. The method in accordance with any of D1-D34, wherein the PVB feedstock comprises less than 10, less than 5, less than 4, less than 3, less than 2, or less than 1, or less than 0.5 weight percent of solid contaminants, based on the total weight of the PVB feedstock.
D36. The method in accordance with any of D1-D35, wherein the PVB feedstock comprises at least 0.01, at least 0.1, at least 0.2, at least 0.3, at least 0.4, at least 0.5, at least 1, at least 1.5, at least 2, at least 2.5, at least 3, at least 3.5, at least 4, at least 4.5, or at least 5 and/or less than 50, less than 40, less than 30, less than 25, less than 20, less than 15, less than 10, less than 9, less than 8, less than 7, less than 6, less than 5, less than 4, less than 3, less than 2, or less than 1 weight percent of non-soluble components, based on the total weight of the PVB feedstock.
D37. The method in accordance with D36, wherein the non-soluble components comprise at least one polymer, wherein the polymer comprises a polyolefin, a polyester, a rubber, a polyamide, a polystyrene, or a combination thereof, and wherein the PVB feedstock comprises at least 0.01, at least 0.1, at least 0.2, at least 0.3, at least 0.4, at least 0.5, at least 1, at least 1.5, at least 2, at least 2.5, at least 3, at least 3.5, at least 4, at least 4.5, or at least 5 and/or less than 50, less than 40, less than 30, less than 25, less than 20, less than 15, less than 10, less than 9, less than 8, less than 7, less than 6, less than 5, less than 4, less than 3, less than 2, or less than 1 weight percent of the polymer.
D38. The method in accordance with D36, wherein the non-soluble components comprise rubber, and the PVB feedstock comprises at least 0.01, at least 0.1, at least 0.2, at least 0.3, at least 0.4, at least 0.5, at least 1, at least 1.5, at least 2, at least 2.5, at least 3, at least 3.5, at least 4, at least 4.5, or at least 5 and/or less than 50, less than 40, less than 30, less than 25, less than 20, less than 15, less than 10, less than 9, less than 8, less than 7, less than 6, less than 5, less than 4, less than 3, less than 2, or less than 1 weight percent of the rubber.
D39. The method in accordance with D36, wherein the non-soluble components comprise glass, metal, a salt, a silicate, calcium, a calcium derivative, a sodium derivative, or combinations thereof, and the PVB feedstock comprises at least 0.01, at least 0.1, at least 0.2, at least 0.3, at least 0.4, at least 0.5, at least 1, at least 1.5, at least 2, at least 2.5, at least 3, at least 3.5, at least 4, at least 4.5, or at least 5 and/or less than 50, less than 40, less than 30, less than 25, less than 20, less than 15, less than 10, less than 9, less than 8, less than 7, less than 6, less than 5, less than 4, less than 3, less than 2, or less than 1 weight percent of glass, metal, a salt, a silicate, calcium, a calcium derivative, a sodium derivative, or combinations thereof.
D40. A method of recycling polyvinyl butyral (PVB), the method comprising: producing a plurality of PVB particles from fresh polyvinyl alcohol and fresh butyraldehyde in the presence of water; hydrolyzing, in the presence of at least one aminofunctional compound, a quantity of the PVB particles to produce a solution comprising regenerated PVOH and one or more butyl imine derivatives; and producing, in the presence of water, additional PVB particles from the regenerated PVOH.
D41. The method in accordance with D40, wherein the at least one aminofunctional compound comprises at least one of monofunctional amines, bifunctional amines, aromatic amines, ethanol amine, methyl amine, ethyl amine, ethyl diamine, propyl diamine, butyl amine, or ammonia.
D42. The method in accordance with any of D40 and D41 further comprising reacting the regenerated PVOH with at least one of fresh butyraldehyde or fresh PVOH to produce regenerated PVB.
D43. The method in accordance with any of D40-D42 further comprising cooling the regenerated PVOH prior to the reacting step.
D44. The method in accordance with any of D40-D43 further comprising: reacting the regenerated PVOH with at least one of fresh butyraldehyde or fresh PVOH to produce the regenerated PVB and a first liquid product; and recovering the first liquid product comprising the one or more butyl imine derivatives.
D45. The method in accordance with any of D40-D44 further comprising precipitating, in the presence of alcohol, the regenerated PVOH from the solution.
D46. The method in accordance with any of D40-D45 further comprising: recovering a second liquid product separated from the precipitated PVOH; and recovering the one or more butyl imine derivatives from the second liquid product.
D47. The method in accordance with D46, wherein recovering the one or more butyl imine derivatives comprises performing at least one of liquid-liquid extraction or distillation on the second liquid product.
D48. The method in accordance with any of D40-D47, wherein the hydrolyzing is carried out in the presence of an acid catalyst.
D49. The method in accordance with D48, wherein the acid catalyst comprises at least one of organic sulfonic acid, nitric acid, sulfuric acid, or hydrochloric acid.
D50. The method in accordance with any of D48 and D49 further comprising producing the regenerated PVB in the presence of the same acid catalyst used in the hydrolyzing of the PVB particles.
D51. The method in accordance with any of D40-D50, wherein the hydrolyzing is carried out at a temperature within a range between about 70° C. and about 250° C.
D52. The method in accordance with any of D48-D51, wherein the hydrolyzing is carried out at a temperature within a range between about 70° C. and about 150° C. when the hydrolysis step occurs in the presence of the acid catalyst.
D53. The method in accordance with any of D40-4D7 and D51, wherein the hydrolyzing is carried out at a temperature within a range between about 150° C. and about 250° C. when the hydrolysis step does not occur in the presence of an acid catalyst.
D54. The method in accordance with any of D40-D53, wherein the hydrolyzing of the PVB particles is carried out in the presence of an alcohol.
D55. The method in accordance with any of D40-D54 further comprising dissolving the PVB particles in a solvent prior to the hydrolysis step.
D56. The method in accordance with any of D54 and D55 further comprising dissolving the PVB particles in the solvent comprising the alcohol.
D57. The method in accordance with any of D40-D56 further comprising: inspecting the regenerated PVB for at least one of oversizing, visual defects, compositional defects, gelling, or contamination; separating on-spec PVB from off-spec PVB based on the inspection; and hydrolyzing the off-spec PVB to produce additional regenerated PVOH.
D58. The method in accordance with D57 further comprising size-reducing the off-spec PVB prior to the hydrolyzing of the off-spec PVB.
D59. The method in accordance with any of D57 and D58 further comprising size-reducing the off-spec PVB to an average particle size of less than about 400 microns, 300 microns, or 200 microns, or between about 200 and about 400 microns.
D60. The method in accordance with any of D40-D59 further comprising recovering and storing the regenerated PVOH from the solution.

Additional advantages of the various embodiments will be apparent to those skilled in the art upon review of the disclosure herein. It will be appreciated that the various embodiments described herein are not necessarily mutually exclusive unless otherwise indicated herein. For example, a feature described or depicted in one embodiment may also be included in other embodiments but is not necessarily included. Thus, the present disclosure encompasses a variety of combinations and/or integrations of the specific embodiments described herein.

### EXAMPLES

### Example 1

A three liter Parr reactor was charged with 15 parts of PVB resin of 18.7% PVOH, 0.25 parts of EDTA, and 1000 parts of water while stirring at 300 rpm. The mixture was heated to 200° C. and held for 6 hours. The resulting clear solution was cooled to room temperature and determined to contain 0.94% total solids.

### Example 2

A one liter three-neck jacketed glass reactor was charged with 10 parts of PVB resin of 18.7% PVOH, 1000 parts of water, and 14.2 parts of 70% wt nitric acid while stirring at 300 rpm. The mixture was heated to 85° C. and held for 6 hours. The resulting suspension was cooled to room temperature and neutralized with 8.83 parts KOH to a pH of 7. After filtration and drying, 8 parts of PVB resin of 47% PVOH was obtained.

### Example 3

A one liter three-neck jacketed glass reactor was charged with 40 parts of PVB resin of 18.7% PVOH, 1000 parts of water, and 14.2 parts of 70% wt nitric acid while stirring at 300 rpm. The mixture was heated to 90° C. and held for 6 hours. The resulting suspension was cooled to room temperature and neutralized with 8.83 parts KOH to a pH of 7. After filtration and drying, 36 parts of PVB resin of 35.1% PVOH was obtained.

### Example 4

A one liter three-neck jacketed glass reactor was charged with 10 parts of PVB resin of 18.7% PVOH, 1000 parts of water, and 14.2 parts of 70% wt nitric acid while stirring at 300 rpm. The mixture was heated to 85° C. and held for 12.5 hours. The resulting clear solution was cooled to room temperature and neutralized with 8.83 parts KOH to a pH of 7. The solution was placed in an aluminum tray and dried in an oven at 45° C. for two days to yield a film. The film was washed with water to remove salts and yielded 7 parts of dried PVOH.

### Example 5

A one liter three-neck jacketed glass reactor was charged with 20 parts of PVB resin of 18.7% PVOH, 1000 parts of water, 0.16 parts of EDTA, and 14.2 parts of 70% wt nitric acid while stirring at 300 rpm. The mixture was heated to 80° C. and held for 26 hours. The resulting clear solution was cooled to room temperature and neutralized with 8.83 parts KOH to a pH of 7. The solution was placed in an aluminum tray in an oven at 45° C. for two days to yield a film. The dried film was washed with water to remove salts and yielded 13 parts of dried PVOH.

### Example 6

A one liter three-neck jacketed glass reactor or was charged with 40 parts of PVB resin of 18.7% PVOH, 1000 parts of water, 0.16 parts of EDTA, and 14.2 parts of 70% wt nitric acid while stirring at 300 rpm. The mixture was heated to 90° C. and held for 26 hours. The resulting clear solution was cooled to room temperature and neutralized with 8.83 parts KOH to a pH of 7. The solution was placed in an aluminum tray in an oven at 45° C. for two days to yield a film. The dried film was washed with water to remove salts and yielded 25 parts of dried PVOH.

### Example 7

A one liter three-neck jacketed glass reactor was charged with 2 parts of PVB resin of 10.5% PVOH, 1000 parts of water, 0.16 part of EDTA, and 14.2 parts of 70% wt nitric acid while stirring at 300 rpm. The mixture was heated to 80° C. and held for 40 hours. The resulting clear solution was cooled to room temperature and neutralized with 8.83 parts KOH to a pH of 7. The solution was placed in an aluminum tray in an oven at 45° C. for two days to yield a film. The dried film was washed with water to remove salts and yielded 1.4 parts of dried PVOH.

### Example 8

A one liter three-neck jacketed glass reactor was charged with 200 parts of post-consumer recycled PVB interlayer flakes (10×10 mm), and 1000 parts water. The pH of the mixture was adjusted to between 1.5 and 2 with diluted sulfuric acid. The mixture was heated to 50° C. and held for one hour with stirring. The resulting slurry was filtered and washed before being air dried.

### Example 9

A mixture of 500 parts alcohol (91% ethanol and 9% water) and 200 parts of DI water were charged to a one liter three-neck jacketed glass reactor. To the stirred mixture, 100 parts of PVB flakes from the above example was added and stirred for 4 hours at room temperature (22° C.). The resulting mixture was then filtered and the above process was repeated using the filtered polymer flakes five more times to yield 65 parts dried PVB resin flakes. 45 parts of these PVB resin flakes and 1000 parts of alcohol (91% ethanol and 9% water) was charged to a one liter three-neck jacketed glass reactor. The mixture was heated to 70° C. with stirring at 200 rpm and held for two hours. The dissolved mixture had total solids of 4.3% and was to be used for the next example.

### Example 10

A one liter three-neck jacketed glass reactor was charged with 1000 parts of water, 0.16 parts of EDTA, 14.2 parts of 70% wt nitric acid while stirring at 300 rpm. The mixture was heated to 80° C. and to this mixture 200 parts of the solution from Example 9 was added over a period of two hours and the mixture was held at 80° C. with stirring at 400 rpm for 22 hours until the suspended polymer was dissolved. The resulting solution was filtered hot with 1 micron retention ErtelAlsop M-503p filter under pressure to yield a clear solution which was cooled to room temperature and neutralized with 8.83 parts KOH to a pH of 7. The solution was placed in an aluminum tray in an oven at 45° C. for two days to yield a film. The dried film was washed with water to remove all the salts and yielded 6 parts of dried PVOH.

### DEFINITIONS

It should be understood that the following is not intended to be an exclusive list of defined terms. Other definitions may be provided in the foregoing description, such as, for example, when accompanying the use of a defined term in context.

As used herein, the terms “a,” “an,” and “the” mean one or more.

As used herein, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination, B and C in combination; or A, B, and C in combination.

As used herein, the phrase “at least a portion” includes at least a portion and up to and including the entire amount or time period.

As used herein, the term “chemical recycling” refers to a PVB recycling process that includes a step of chemically converting waste PVB into lower molecular weight polymers, oligomers, monomers, and/or non-polymeric molecules (e.g., carbon monoxide, C2-C4 aldehydes, ethylene, and propylene) that are useful by themselves and/or are useful as feedstocks to another chemical production process(es).

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the term “directly derived” refers to having at least one physical component originating from recycled PVB.

As used herein, the terms “having,” “has,” and “have” have the same open-ended meaning as “comprising,” “comprises,” and “comprise” provided above.

As used herein, the terms “including,” “include,” and “included” have the same open-ended meaning as “comprising,” “comprises,” and “comprise” provided above.

As used herein, the term “interlayer” refers to a single or multiple layer polymer sheet suitable for use with at least one rigid substrate to form a multiple layer panel.

As used herein, the term “isolated” refers to the characteristic of an object or objects being by itself or themselves and separate from other materials, in motion or static.

As used herein, the term “preprocessing” refers to preparing PVB compositions for chemical recycling using one or more of the following steps: (i) comminuting, (ii) particulating, (iii) washing, (iv) drying, and/or (v) separating.

As used herein, the terms “recycled content” and “regenerated” refer to being or comprising a composition that is directly and/or indirectly derived from a recycled/waste PVB composition.

As used herein, the terms “single-sheet” interlayer and “monolithic” interlayer refer to interlayers formed of one single resin sheet, while the terms “multiple layer” and “multi-layer” interlayer refer to interlayers having two or more resin sheets coextruded, laminated, or otherwise coupled to one another.

### NUMERICAL RANGES

The present description uses numerical ranges to quantify certain parameters relating to the invention. It should be understood that when numerical ranges are provided, such ranges are to be construed as providing literal support for claim limitations that only recite the lower value of the range as well as claim limitations that only recite the upper value of the range. For example, a disclosed numerical range of 10 to 100 provides literal support for a claim reciting “greater than 10” (with no upper bounds) and a claim reciting “less than 100” (with no lower bounds).

Additionally, it should be understood that a listing of numerical values following a descriptor, such as “at least” and “not more than,” provides literal support for a range based on all of the numerical values following that descriptor. For example, a statement specifying “at least 2, 5, or 10 and/or not more than 100, 50, or 25” would provide literal support for ranges of “at least 25,” “not more than 50,” and “at least 10 and not more than 25.”

### CLAIMS NOT LIMITED TO DISCLOSED EMBODIMENTS

The preferred forms of the invention described above are to be used as illustration only, and should not be used in a limiting sense to interpret the scope of the present invention. Modifications to the exemplary embodiments, set forth above, could be readily made by those skilled in the art without departing from the spirit of the present invention.

The inventors hereby state their intent to rely on the Doctrine of Equivalents to determine and assess the reasonably fair scope of the present invention as it pertains to any apparatus not materially departing from but outside the literal scope of the invention as set forth in the following claims.

1. A method of recycling polyvinyl butyral (PVB), the method comprising: hydrolyzing or partially hydrolyzing a PVB feedstock to produce a solution comprising regenerated polyvinyl alcohol (PVOH) derived from the PVB feedstock.

2. The method in accordance with claim 1, wherein the hydrolyzing or partially hydrolyzing does not occur in the presence of a catalyst.

3. The method in accordance with claim 1, wherein the hydrolyzing or partially hydrolyzing does not occur in the presence of a catalyst and is carried out at a temperature within a range between about 150° C. and about 250° C.

4. The method in accordance with claim 1, wherein the hydrolyzing or partial hydrolyzing occurs in the presence of an acid catalyst.

5. The method in accordance with claim 4, wherein the acid catalyst comprises at least one of organic sulfonic acid, nitric acid, sulfuric acid, or hydrochloric acid.

6. The method in accordance with claim 4, wherein the hydrolyzing or partially hydrolyzing is carried out in the presence of one or more of an acid catalyst or a co-catalyst that forms a labile hydrolyzable molecule.

7. The method in accordance with claim 5, wherein the hydrolyzing or partial hydrolyzing is carried out in the presence of the acid catalyst and at a temperature within a range between about 70° C. and about 150° C.

8. The method in accordance with claim 7, where the PVB feedstock is hydrolyzed to PVOH with a conversion of at least 90 percent.

9. The method in accordance with claim 7, wherein the PVB feedstock is partially hydrolyzed to a conversion between 20 percent and 90 percent.

10. The method in accordance with claim 7, wherein the partially hydrolyzing of the PVB feedstock produces a slurry that comprises between 25 percent and 75 percent water-insoluble PVB by weight.

11. The method in accordance with claim 7, wherein the partially hydrolyzing of the PVB feedstock produces a slurry that comprises from about 75 percent to about 99 percent water by weight.

12. The method in accordance with claim 1, further comprising cooling the regenerated PVOH prior to the reacting step.

13. The method in accordance with claim 1, further comprising centrifuging the solution to remove one or more non-soluble components from the solution prior to a filtration step.

14. The method in accordance with claim 1, where the PVB feedstock is derived from at least one of post-industrial recycle or post-consumer recycle material.

15. The method in accordance with claim 1, wherein the PVB feedstock has a residual PVOH content of at least 15, and/or not more than 70 percent.

16. The method in accordance with claim 1, wherein the PVB feedstock comprises two or more PVB resins having different compositions from one another.

17. The method in accordance with claim 1, wherein the PVB feedstock comprises two or more PVB resins having different residual PVOH contents from one another.

18. The method in accordance with claim 1, wherein the PVB feedstock comprises at least 10 and/or not more than 70 phr of plasticizer, based on the total weight of the PVB feedstock.

19. The method in accordance with claim 1. further comprising extracting plasticizer from the PVB feedstock.

20. The method in accordance with claim 1, further comprising size-reducing the PVB feedstock prior to the hydrolyzing step to an average particle size between about 200 and about 400 microns.

21. The method in accordance with claim 1, further comprising reacting the residual PVOH with butyraldehyde to produce the regenerated PVB having a residual PVOH content of between 1 percent and 90 percent.

22. The method in accordance with claim 1, further comprising reacting the residual PVOH with butyraldehyde to produce regenerated PVB having a target residual PVOH content, wherein the PVB feedstock has a residual PVOH content that is greater than 4 percent from the target residual PVOH content.

23. The method in accordance with claim 1, further comprising recovering butyraldehyde produced in the hydrolyzing step.

24. The method in accordance with claim 1, further comprising reacting the residual PVOH with butyraldehyde recovered from the hydrolyzing step to produce regenerated PVB.
